(19) United States
(12) Patent Application Publication
(10) Pub. No.: US 2021/0230781 A1
(43) Pub. Date: Jul. 29, 2021

(54) CROSS-LINKED NON-WOVENS PRODUCED BY MELT BLOWING REVERSIBLE POLYMER NETWORKS

(71) Applicant: CUMMINS FILTRATION IP, INC., Columbus, IN (US)

(72) Inventors: Christopher J. Ellison, Eden Prairie, MN (US); Kailong Jin, Minneapolis, MN (US); Frank S. Bates, Saint Louis Park, MN (US); William C. Haberkamp, Cookeville, TN (US); Kan Wang, Peachtree City, GA (US)

(73) Assignee: CUMMINS FILTRATION IP, INC., Columbus, IN (US)

(21) Appl. No.: 15/734,849

(22) PCT Filed: May 13, 2019
(86) PCT No.: PCT/US2019/032015

§ 371 Date: Dec. 3, 2020

Related U.S. Application Data
(60) Provisional application No. 62/682,549, filed on Jun. 8, 2018.

(51) Int. Cl. D04H 1/56; B01D 39/16; D04H 3/16; C08F 220/18

(52) U.S. Cl. CPC D04H 1/56; B01D 39/1623; D04H 3/16; D10B 2505/04; B01D 2239/10; B01D 2239/0618; B01D 2239/0622; C08F 220/1804

(57) ABSTRACT

A method comprises providing a polymer. The polymer is heated to a first predetermined temperature so as to liquefy the polymer. The liquefied polymer is formed into a polymer fiber. The polymer fiber is cross-linked to form a cross-linked polymer fiber comprising a polymer network by at least one of cooling the polymer fiber to a second predetermined temperature lower than the first predetermined temperature or exposing the polymer fiber to a cross-linking stimulus, the cross-linked polymer fiber capable of being decross-linked by heating to a third predetermined temperature above a characteristic decross-linking temperature of the polymer.

### CROSS-REFERENCE TO RELATED APPLICATIONS

The present application claims priority to and benefit of U.S. Provisional Application No. 62/682,549 filed Jun. 8, 2018, the entire disclosure of which is incorporated herein by reference in its entirety.

### TECHNICAL FIELD

The present disclosure relates generally to methods for fabricating filter media for filter elements.

### BACKGROUND

Nonwovens, comprising randomly or sometimes directionally oriented polymer fibers, are used in applications ranging from disposable wipes to filtration media. Cross-linked fibers are extremely attractive because of their superior mechanical properties (e.g., high modulus, elastic recovery, etc.) and chemical resistance over linear thermoplastic fibers. For example, cross-linked fibers are particularly useful for filtration applications (e.g., in automotive filters) under harsh chemical conditions and other advanced applications including biological tissue scaffolds and hydrogels. A number of conventional methods for producing cross-linked fibers have mainly focused on electrospinning and force spinning, where cross-linked fibers are formed either in-situ (usually by simultaneous UV curing) during fiber spinning or in an additional cross-linking step (by thermal or UV curing) after fiber spinning. These cross-linked fibers are typically composed of permanent cross-links, which cannot be decross-linked and thereby, cannot be reprocessed/recycled.

### SUMMARY

Embodiments described herein relate generally to systems and methods for forming cross-linked polymer fiber, and in particular to liquefying a polymer in a melt blowing die and melt blowing the liquefied polymer into polymer fibers which is then cross-linked into a polymer fiber network. The cross-linked polymer fiber is capable of being decross-linked by exposing to an external stimulus, e.g., by heating to a third predetermined temperature above a characteristic decross-linking temperature of the polymer.

In a first set of embodiments, a method comprises providing a polymer. The polymer is heated to a first predetermined temperature so as to liquefy the polymer. The liquefied polymer is formed into a polymer fiber. The polymer fiber is cross-linked to form a cross-linked polymer fiber comprising a polymer network by at least one of cooling the polymer fiber to a second predetermined temperature lower than the first predetermined temperature or exposing the polymer fiber to a cross-linking stimulus, the cross-linked polymer fiber capable of being decross-linked by heating to a third predetermined temperature above a characteristic decross-linking temperature of the polymer.

In another set of embodiments, a method comprises disposing a polymer into a melt blowing die. The polymer is heated to a first predetermined temperature in the melt blowing die so as to liquefy the polymer. The liquefied polymer is extruded through an orifice of the melt blowing die towards a substrate so as to form a polymer fiber. The polymer fiber is cross-linked to form a cross-linked polymer fiber comprising a polymer network by at least one of cooling the polymer fiber to a second predetermined temperature lower than the first predetermined temperature or exposing the polymer fiber to a cross-linking stimulus, the cross-linked polymer fiber capable of being decross-linked by heating to a third predetermined temperature above a characteristic decross-linking temperature of the polymer.

In still another set of embodiments, a filter media for a fluid filter is prepared by a process comprising disposing a polymer into a melt blowing die. The polymer is heated to a first predetermined temperature in the melt blowing die so as to liquefy the polymer. The liquefied polymer is extruded through an orifice of the melt blowing die so as to form a polymer fiber. The polymer fiber is cross-linked to form a cross-linked polymer fiber comprising a polymer network by at least one of cooling the polymer fiber to a second predetermined temperature lower than the first predetermined temperature or exposing the polymer fiber to a cross-linking stimulus, the cross-linked polymer fiber capable of being decross-linked by heating to a third predetermined temperature above a characteristic decross-linking temperature of the polymer.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims, taken in conjunction with the accompanying drawings. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

FIG. 1 is a schematic flow diagram of a method of forming a cross-linked polymer fiber network, according to an embodiment.

FIG. 2 is a schematic flow diagram of a method of forming a cross-linked polymer fiber network via melt blowing, according to an embodiment.

FIG. 3 is a schematic illustration of a melt blowing apparatus for forming a polymer fiber network, according to an embodiment.

FIG. 4 is a schematic illustration of a filter media including a cross-linked polymer fiber, according to an embodiment.

FIG. 5 illustrates a Diels-Alder based polymer that can be melt blown into liquid polymer fibers such that the Diels-Alder bonds are broken, and reform on cooling such that a cross-linked polymer fiber network is formed.

FIG. 6A is a thermoreversible furan-maleimide Diels-Alder reaction; FIG. 6B are structures of FMA-BMA copolymer and M2 monomer; FIG. 6C shows synthesized FMA-BMA/M2 networks through Diels-Alder reaction can undergo decross-linking through retro-Diels-Alder reaction upon heating.

FIG. 7 is a ¹H NMR spectrum for neat 15-85 mol % FMA-BMA copolymer (Mₙ=17.0 kg/mol). FMA content in the copolymer is determined to be about 14.5 mol % based on the ratio between a and b peak areas from the ¹H NMR spectrum.

FIG. 8 is a ¹H NMR spectrum for neat 15-85 mol % FMA-BMA copolymer (Mₙ=9.0 kg/mol). FMA content in the copolymer is determined to be about 16.5 mol % based on the ratio between a and b peak areas from the ¹H NMR spectrum.

FIG. 9 is a ¹H NMR spectrum for non-reacted bulk FMA-BMA/M2 mixture (15-85 mol % FMA-BMA copolymer, Mₙ=17.0 kg/mol) with a stoichiometric balance between furan and maleimide functional groups (i.e., furan:maleimide=1:1).

FIG. 10A are DSC heat flow curves and FIG. 10B are first derivative heat flow curves for non-reacted bulk FMA-BMA/M2 mixture (15-85 mol % FMA-BMA copolymer with Mn=17.0 kg/mol; furan:maleimide=1:1) after annealing at RT for different amounts of time. The bottom curves correspond to the samples with additional post-curing at 70 degrees Celsius for 2 days.

FIG. 11 is a plot of gel fraction and T_{g} versus annealing time at RT for bulk FMA-BMA/M2 mixture and fibers.

FIG. 12A is a FTIR spectra of non-reacted and cured FMA-BMA/M2 mixtures, cured fiber, and cured mixture after annealing at 162 degrees Celsius for 15 min; FIG. 12B are DSC curves for (1) cured FMA-BMA/M2 mixture, (2) sample 1 after annealing at 162 degrees Celsius for 15 min, (3) sample 2 after annealing at RT for 5 days, (4) FMA-BMA, and (5) M2.

FIG. 13 are ATR-FTIR spectra from 2000 to 650 cm⁻¹ for non-reacted and cured bulk FMA-BMA/M2 mixture, cured fiber, and cured mixture after decross-linking at 162 degrees Celsius for 15 min.

FIG. 14A-B are plots of elastic (G′) and viscous (G″) moduli versus frequency for bulk FMA-BMA/M2 mixture (15-85 mol % FMA-BMA copolymer with Mₙ=17.0 kg/mol; furan:maleimide=1:1) at 160 degrees Celsius (FIG. 14A) and 90 degrees Celsius (FIG. 14B).

FIG. 15A-C are plots of G′ and loss G″ moduli versus temperature for FMA-BMA/M2 mixture (FIG. 15A); FMA-BMA copolymer (FIG. 15B); FIG. 15C are plots of η* versus temperature for FMA-BMA/M2 mixture and FMA-BMA alone; and FIG. 15D are plots of η* versus frequency at various temperatures for FMA-BMA/M2.

FIG. 16A-B are plots of G′ and G″ moduli versus temperature for bulk FMA-BMA/M2 mixture with 17.0 kg/mol FMA-BMA and furan:maleimide=2:1 (FIG. 16A) and bulk FMA-BMA/M2 mixture with 9.0 kg/mol FMA-BMA and furan:maleimide=1:1 (FIG. 16B).

FIG. 17 are plots of complex viscosity η* versus annealing time at 162 degrees Celsius for bulk FMA-BMA/M2 mixture with furan:maleimide=1:1 (solid line) and furan:maleimide=2:1 (dotted line) as well as neat FMA-BMA copolymer (dashed line). Mₙ=17.0 kg/mol for the FMA-BMA copolymer here.

FIGS. 18A-B are representative SEM images of the melt blown FMA-BMA/M2 fibers obtained at 0.4 g/(min hole) polymer flow rate after annealing at (FIG. 18A) 130 degrees Celsius for 12 h and (FIG. 18B) 165 degrees Celsius for 15 min.

FIGS. 19A and 19B are representative SEM images of melt blown FMA-BMA/M2 fibers with a polymer flow rate of (FIG. 19A) 0.4 and (FIG. 19B) 0.2 g/(min hole); FIGS. 19C and 19D are statistical analyses of fiber diameters are provided, the inset in FIG. 19A is a representative photograph of the fiber mats.

FIG. 20 shows cross-linking chemistry of an anthracene based polymer AN-MA-nBA on exposure to ultraviolet (UV)-light.

FIG. 21 shows decross-linking of the AN-MA-nBA polymer on heating to a temperature of greater than 225 degrees Celsius.

FIG. 22 are plots of G′ or G″ at various frequencies for cross-linked and decross-linked AN-MA-nBA polymer.

FIG. 23 are plots of size exclusion chromatograph (SEC) of AN-MA-nBA monomers and polymers with dimethylformamide (DMF) as eluent.

FIG. 24 are plots of G′ or G″ of an AN-MA-nBA copolymer film.

FIG. 25 are plots of differential scanning calorimetry (DSC) of AN-MA-nBA films, cross-linked and decross-linked polymer.

FIG. 26 are plots of absorbance vs wavelength showing reversibility of AN-MA-nBA copolymer networks.

FIG. 27 shows a process for melt blowing an anthracene liquefied polymer to decross-link the polymer network and then UV cross-linking the polymer to form a non-woven polymer fiber network.

FIG. 28A-C are plots of viscosity of AN-MA-nBa polymer at various temperatures, frequencies and times at 175 degrees Celsius temperature.

FIG. 29A-D are scanning electron micrograph (SEM) images of the melt blown linear AN-MA-nBA polymer fibers.

FIG. 30 is a bar graph of relative frequency vs fiber diameter of melt blown AN-MA-nBA polymer fibers of FIG. 29A-D.

FIG. 31A-D are SEM images of the melt blown linear AN-MA-nBA polymer fibers after UV crosslinking.

FIG. 32 is a bar graph of relative frequency vs fiber diameter of melt blown AN-MA-nBA polymer fiber networks of FIG. 31A-D.

FIG. 33A-D are SEM images of melt blown AN-MA-nBA polymer fibers after UV cross-linking THF swelling and drying.

FIG. 34 is a bar graph of relative frequency vs fiber diameter of melt blown AN-MA-nBA polymer fiber networks of FIG. 33A-D.

FIG. 35 are plots of thermal properties of AN-MA-nBA films and fibers at various states.

### DETAILED DESCRIPTION

Embodiments described herein relate generally to systems and methods for forming cross-linked polymer fiber, and in particular to liquefying a polymer in a melt blowing die and melt blowing the liquefied polymer into polymer fibers which is then cross-linked into a polymer fiber network.

Compared to other fiber spinning techniques, melt blowing is a relatively environmentally friendly (solventless) and economical (high throughput) process for producing nonwoven mats, for example, producing filter media. Melt blowing combines extrusion of a polymer melt through small orifices (i.e., melt blowing die) with attenuation of the hot extrudate by hot high-velocity air jets to form molten fibers in a single step. Molten fibers are cooled down below the solidification temperature (e.g., glass transition temperature (T_{g}) or crystallization temperature (T_{c}) of the polymer), for example, by ambient air, leading to solidified fibers. An appropriate melt viscosity is needed for extrusion and fiber attenuation. Hence, linear thermoplastic polymers (e.g., poly(butylene terephthalate), polyethylene, polypropylene, etc.) with relatively low melt viscosity are usually selected for melt blowing.

Conventional cross-linked polymers or thermosets (e.g., vulcanized rubber) are not suitable for melt blowing since they cannot be re-melted after curing due to the strong, fixed covalent bonds. Reactive monomer mixtures, e.g., multifunctional amine and epoxy monomers, are not suitable either since they may undergo potential cross-linking reactions within equipment during melt processing which could damage extrusion equipment or die orifices.

Embodiments described herein provide a one-step approach for producing cross-linked fibers by melt blowing a thermoreversible polymer network with dynamic cross-links. Unlike conventional thermosets, reversible polymer networks can undergo dynamic molecular rearrangement reactions to achieve macroscopic flow in response to external stimuli (e.g., heat), exhibiting self-healing capability, reprocessability and recyclability.

Embodiments of the polymer fiber networks described herein may be provide several benefits including, for example: (1) providing a novel reactive cross-linking strategy for melt blown fibers which is different from traditional solidification methods which are based on glass transition and crystallization; (2) allowing melt blowing of reversible polymer networks including any kind of dynamic networks; (3) forming of filter media with stiffer fiber structure and better thermal and chemical resistance than conventional filter media; and (4) allowing repair of damaged filter media by using thermal cycling to decross-link the polymer fiber network based filter media and recross-linking the polymer network.

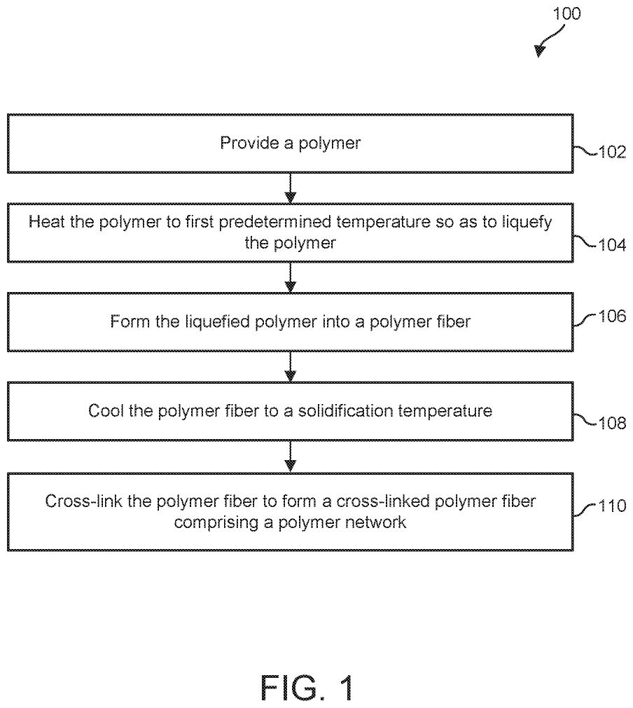

FIG. 1 is a schematic flow diagram of an example method 100 for forming a non-woven polymer fiber network. The method comprises providing a polymer, at 102. In some embodiment, the polymer includes a cross-linked polymer having a reversible polymer network. For example, the polymer may include a plurality of polymer strands that are cross-linked or capable of being cross-linked to each other via a secondary ionic or covalent reversible reaction so as to form a polymer network. For example, the polymer network maybe cross-linked or capable of being cross-linked via Diels-Alder linkages, anthracene-dimer linkages or alkoxyamine linkages.

In some embodiments, the polymer may be cross-linked or capable of being cross-linked via a general reversible covalent reaction, for example, a reversible addition reaction, an urazole formation reaction, an urea formation reaction, a reversible condensation reaction, an imine bond formation reaction, an acylhydrazone formation reaction, an oxime formation reaction, an aminal formation reaction, an acetal formation reaction, an aldol formation reaction, an ester formation reaction, a boronic ester formation reaction, or a disulfide bond formation reaction.

In other embodiments, the polymer network may be cross-linked or capable of being cross-linked via a dynamic reversible covalent reaction such as, for example, a reversible exchange reaction, an exchange reaction of C═N bond, transamination, transoximization, hydrazine exchange, exchange reaction of S-S bond, disulfide exchange, disulfide-thiol exchange, thiuram disulfide exchange, exchange reaction of D-O bond, transcarbamoylation, transesterification, Nicholas ether-exchange, hemiaminal ether exchange, exchange reaction of C—C, C═C and C≡C bonds, carbon radical exchange, olefin metathesis, alkyne metathesis, exchange reaction of C—N bond, transamidation, urea exchange, transamination, amine exchange, pyrazolotraizinones exchange, transalkylation, trithiocarbonate exchange, thiazolidines exchange, siloxane equilibration or alkoxyamine equilibration.

In particular embodiments, the polymer comprises a poly[(furfuryl methacrylate)-co-(butyl methacrylate)] (FMA-BMA) copolymer and a bismaleimide (M2) monomer cross-linked via furan-maleimide linkages generated by a Diels-Alder reaction. In other embodiments, the polymer comprises anthracene-functionalized poly[(methyl acrylate)-co-(n-butyl acrylate) (AN-MA-nBA) copolymer cross-linked into a polymer network via linkages generated by an anthracene dimerization reaction. In still other embodiments, the polymer may comprise functionalities including, but not limited to cinnamyl functionality, coumarin functionality, styrylpyrene functionality, vinyl and maleimide functionalities, that can undergo reversible photocycloaddition dimerization reaction so as to form the reversible polymer network.

At 104, the polymer is heated to a first predetermined temperature so as to liquefy the polymer. For example, the polymer may comprise a cross-linked polymer and heating the polymer to the first predetermined temperature may be sufficient to break the linkages forming the polymer networks (e.g., Diels-Alders linkages, anthracene-dimer linkages or alkoxyamine linkages) to decross-link the polymer such that the polymer transitions from a solid or gel to a liquid. In some embodiments, the first predetermined temperature may be greater than 100 degrees Celsius. In some embodiment, the first predetermined temperature may be in a range of 110-250 degrees Celsius (e.g., 110, 120, 130, 140, 150, 160, 170, 180, 190, 200, 210, 220, 230, 240 or 250 degrees Celsius inclusive of all ranges and values therebetween). In specific embodiments, the polymer comprises is FMA-BMA-M2 and the first predetermined temperature is in a range of about 160-165 degrees Celsius. In other embodiments, the polymer comprises AN-MA-nBA and the first predetermined temperature is about 220-225 degrees Celsius.

At 106, the liquefied polymer is formed into a polymer fiber. For example, the liquefied polymer may be melt blown towards a substrate to form a polymer fiber which is collected on the substrate. In other embodiments, 3D printing, spray printing, electrospinning, spin coating, casting or any other suitable process may be used to form the polymer fiber from the liquefied polymer.

In some embodiments, the polymer fiber may be cooled to a solidification temperature so as to at least partially solidify the liquefied polymer in the polymer fiber, at 108. The solidification temperature may include, for example, a glass transition temperature or a crystallization temperature of the polymer at which the polymer solidifies.

At 110, the polymer fiber is cross-linked to form a cross-linked polymer fiber comprising a polymer network by at least one of cooling the polymer fiber to a second predetermined temperature lower than the first predetermined temperature or exposing the polymer fiber to a cross-linking stimulus. The cross-linked polymer fiber is capable of being decross-linked by heating to a third predetermined temperature above a characteristic decross-linking temperature of the polymer. The third predetermined temperature may be equal to or different than the first predetermined temperature. For example, the polymer may be formulated so that the polymer included in the polymer fiber may include precursors capable of forming Diels-Alder linkages (e.g., FMA-BMA-M2). In such embodiments, polymer may be cross-linked via Diels-Alder linkages by cooling the liquid polymer to the second predetermined temperature, for example, less than 100 degrees Celsius (e.g., about room temperature). At the second predetermined temperature Diels-Alder linkages reform such that the polymer reverts to a solid or gel state and cross-links into a polymer network. In this manner, cross-linked non-wovens formed from reversible polymer networks may be produced.

In other embodiments, the polymer is formulated such that the polymer in the polymer fiber may include precursors capable of forming anthracene-dimer based linkages (e.g., AN-MA-nBA). In such embodiments, exposing the polymer fiber to the cross-linking stimulus (e.g., an optical, chemical or physical stimulus) may cause anthracene-dimer linkages to reappear causing the polymer to cross-link into a polymer network. In particular embodiments, the cross-linking stimulus may comprise ultra-violet (UV) light or sunlight. For example, UV light may induce the anthracene-dimer linkages previously broken by thermal cycling or annealing (e.g., at a temperature of about 220-225 degrees Celsius) to reform, thereby forming the cross-linked polymer network.

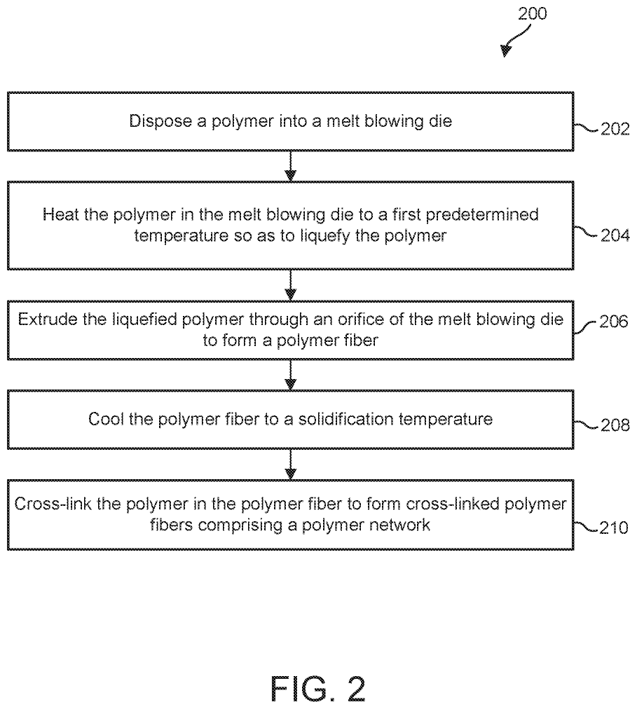

FIG. 2 is a schematic flow diagram of another method 200 for forming a non-woven polymer fiber network via melt blowing, according to an embodiment. The method comprises disposing a polymer into a melt blowing die, at 202. The polymer may comprise cross-linked polymer having a reversible polymer network. For example, the polymer may include a plurality of polymer strands that are further cross-linked or capable of being cross-linked to each other via a secondary ionic or covalent reversible reaction so as to form a polymer network. For example, the polymer network maybe cross-linked or capable of being cross-linked via Diels-Alder linkages, anthracene-dimer linkages, alkoxyamine linkages or any other covalent linkages previously described herein. In particular embodiments, the polymer may comprise FMA-BMA/M2, AN-MA-nBA, or a polyacrylate polymer with any other covalent linkages previously described herein.

The melt blowing die may be formed from cast iron, stainless steel, aluminum or any other suitable heat resistant material. The melt blowing die may include a cavity in which the polymer is disposed and an orifice from which the polymer is extruded. At 204, the polymer is heated to a first predetermined temperature in the melt blowing die so as to liquefy the polymer. For example, the first predetermined temperature may be sufficient to break the linkages forming the polymer networks (e.g., Diels-Alders linkages, anthracene-dimer linkages alkoxyamine linkages) to decross-link the polymer such that the polymer transitions from a solid or gel to a liquid.

In some embodiments, the first predetermined temperature may be greater than 100 degrees Celsius. In some embodiment, the first predetermined temperature may be in a range of 110-250 degrees Celsius (e.g., 110, 120, 130, 140, 150, 160, 170, 180, 190, 200, 210, 220, 230, 240 or 250 degrees Celsius inclusive of all ranges and values therebetween. In some embodiments, the polymer comprises is FMA-BMA-M2 and the first predetermined temperature is in a range of about 160-165 degrees Celsius. In other embodiments, the polymer comprises AN-MA-nBA and the first predetermined temperature is in a range of 220-225 degrees Celsius. In some embodiment, the polymer may be heated to the first predetermined temperature using a stream of heated air, for example, provided proximate to the orifice of the melt blowing die.

In particular embodiments, the polymer may first be preheated to and maintained at a preheat temperature below the first predetermined temperature prior to heating the polymer to the first predetermined temperature. The preheat temperature may be lower than the first predetermined temperature (e.g., less than 100 degrees Celsius). The preheating may be performed by heating the melt blowing die to the preheating temperature.

At 206, the liquefied polymer is extruded through the orifice of the melt blowing die towards a substrate so as to form a polymer fiber. The orifice of the melt blowing die may correspond to a desired diameter of a polymer fiber being formed. A piston or any other positive pressure source may be used to force or extrude the liquefied polymer through the orifice of the melt blowing die. The substrate may be positioned along an axial flow direction of the polymer fiber being extruded through the orifice. For example, the substrate may be positioned at a lower elevation than the melt blowing die with respect to gravity such that a stream of the polymer fiber flows towards the substrate and is collected thereon.

In some embodiments, the polymer fiber may be cooled to a solidification temperature so as to at least partially solidify the liquefied polymer in the polymer fiber, at 208. For example, as the extruded polymer fiber is melt blown towards the substrate, atmospheric air surrounding the melt blowing die may cool the liquefied polymer in the polymer fiber to a glass transition or crystallization temperature of the polymer at which the polymer solidifies. Thus solid polymer fiber is collected on the substrate.

At 210, the liquefied polymer in the liquid polymer fiber is cross-linked to form cross-linked polymer fibers comprising a polymer network by at least one of cooling the polymer fiber to a second predetermined temperature lower than the first predetermined temperature or exposing the polymer to a cross-linking stimulus. The cross-linked polymer fiber is capable of being decross-linked by heating to the first predetermined temperature.

For example, the polymer in the polymer fiber may comprise a Diels-Alder based polymer (e.g., FMA-BMA/M2) formulated to form Diels-Alder linkages on being cooled to the second predetermined temperature (e.g., less than 100 degrees Celsius or room temperature) less than the first predetermined temperature.

In some embodiments, as the polymer fiber is extruded from the orifice of the melt blowing die, the polymer fiber may also cool down to a temperature lower than the first predetermined temperature. The lower temperature atmospheric air may cause Diels-Alder linkages to form in the liquefied polymer, thereby cross-linking the polymer such that the polymer gels, solidifies as well as cross-links enroute to the substrate. The cross-linked polymer fiber is collected on the substrate, for example, as a non-woven mat or layer of the cross-linked polymer fiber. The non-woven polymer mat or layer may be used, for example, as a filter media or a filter media layer of a filter media.

In other embodiments, the liquefied polymer in the liquid polymer fiber may comprise an anthracene based polymer (e.g., AN-MA-nBA) formulated to form anthracene-dimer based linkages on being exposed to a cross-linking stimuli, for example, UV light. In various embodiments, the polymer fiber may be exposed to the cross-linking stimuli (e.g., UV light). For example, solidified polymer fiber may first be collected on the substrate and subsequently exposed to the cross-linking stimuli to cross-link the polymer and form the cross-linked polymer fiber on the substrate.

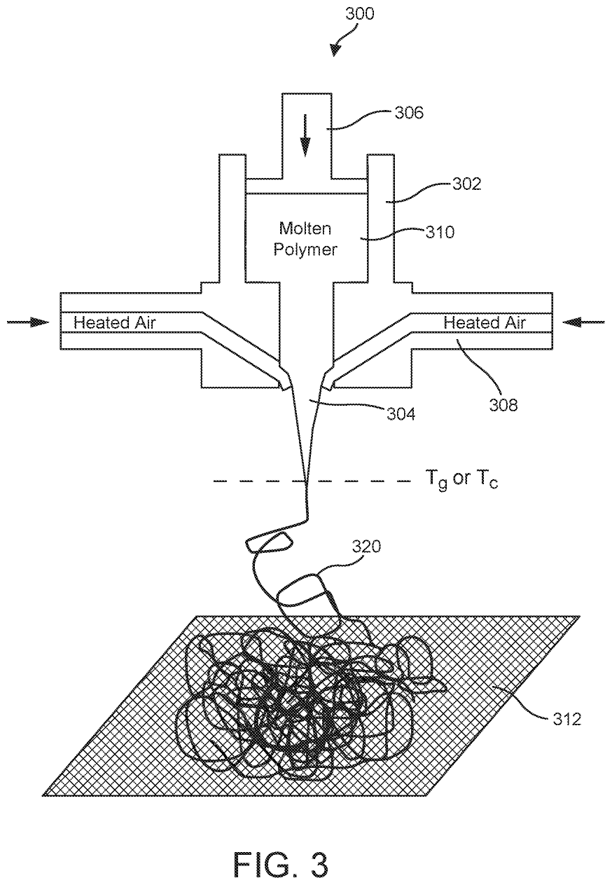

FIG. 3 is a schematic illustration of a melt blowing apparatus 300 which may be used to form polymer fibers using the operations of method 200, according to a particular embodiment. The melt blowing apparatus 300 comprises a melt blowing die 302. A polymer 310 capable of reversibly forming polymer networks (e.g., FMA-BMA/M2, cross-linked AN-MA-nBA or any of the other polymers described herein) is disposed in an internal volume defined by the melt blowing die 302. The melt blowing die 302 defines an orifice 304, and a plunger 306 is configured to be selectively moved towards the orifice 304 so as to force liquefied polymer 310 out of the orifice and form a liquid polymer fiber 320.

The melt blowing die 302 defines a pair of conduits 308 configured to deliver heated air to the orifice 304. The heated air or any other heated gas delivered to the orifice may be at the first predetermined temperature (e.g. in a range of 110-250 degrees Celsius) sufficient to liquefy the polymer 310 (e.g., by breaking cross-links formed between strands of the polymer 310). As a liquid polymer stream is extruded out of the orifice 304 and travels towards a substrate 312, which is positioned below the orifice 304, the liquid polymer stream is cooled to a solidification temperature (e.g., a glass transition temperature (T_{g}) or a crystallization temperature (T_{c}) by the atmospheric air to form a solid polymer fiber 320 which is collected on the substrate.

The polymer fiber 320 is either cooled to a second predetermined temperature lower than the first predetermined temperature via exposure to atmospheric air, or exposed to a cross-linking stimuli (e.g., UV light) which induces the formation of cross-links in the polymer causing the liquefied polymer to gel or solidify. The cross-linked polymer fiber collected on the substrate 312 as a non-woven mat.

In a specific embodiment, the polymer melt blown into polymer fibers using the melt blowing apparatus 300 may include 40-25-35 mol % AN-MA-nBA linear copolymer (Mₙ about 40 kg/mol). The AN-MA-nBA polymer may be preheated to a temperature of about 80 degrees Celsius. The AN-MA-nBA copolymer is then heated to about 175 degrees Celsius sufficient to liquefy the copolymer. The AN-MA-nBA is annealed at about 175 degrees for about 5-10 minutes to allow the copolymer to completely liquefy in the melt blowing die 302. Heated air having an air flow rate in a range of 3-5 standard cubic feet per minute (SCFM) is provide through the conduits 308 for heating the copolymer to about 175 degrees Celsius.

The liquefied AN-MA-nBA copolymer is extruded through the orifice (e.g., having a diameter in a range of 0.1-0.3 mm), for example, a flow rate of 0.1-0.2 gram/min. The air pressure at the orifice 304 may be in a range of 4-6 psi. The substrate 312, which may comprise a stationary substrate covered with aluminum foil and maintained at room temperature (e.g., in a range of 25-30 degrees Celsius) may be positioned at a distance of 50-100 centimeter from the orifice 304. The AN-MA-nBA polymer fiber being extruded out of the orifice 304 is cooled below a solidification temperature as it travels from the orifice 304 to the substrate 312. The speed of the conveyor belt may be varied, for example, to control a thickness of the polymer fiber mat formed thereon. The solidified fiber is further cross-linked by exposing to UV light or sun light at room temperature.

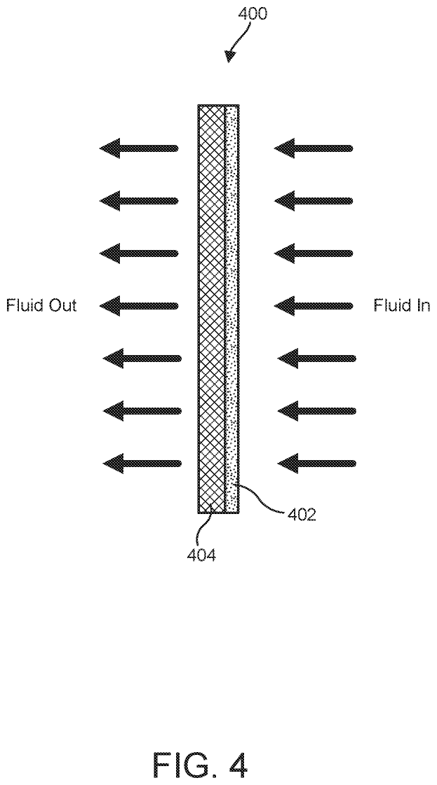

As previously described herein, the non-woven polymer fibers consisting of reversible polymer networks may be used as a filter media or a filter media layer of a filter media. For example, FIG. 4 is a schematic illustration of a filter media 400, according to a particular embodiment. The filter media 200 comprises a base layer 402 and a filter media layer 404. The filter media layer 404 may include a non-woven cross-linked polymer fiber, for example, FMA-BMA/M2, AN-MA-nBA or any other reversible polymer fiber network described herein. The filter media layer 404 may be formed, for example, via melt blowing the polymer into a mat of non-woven cross-linked polymer fibers, the fibers clustered into a dense cross-linked polymer fiber mesh having a predetermined porosity. The porosity of the filter media layer 404 may be controlled during the polymer fiber formation process (e.g., during a melt blowing process) based on the particular application that the filter media 400 is to be used for.

The base layer 402 may comprise a porous substrate or scrim layer for providing structural support to the filter media layer 404. Suitable scrim layers may include spun bonded nonwovens, melt blown nonwovens, needle punched nonwovens, spun laced nonwovens, wet laid nonwovens, resin-bonded nonwovens, woven fabrics, knit fabrics, aperture films, paper, and combinations thereof. In other embodiments, the base layer 402 may be excluded. In still other embodiments, the base layer 402 may include a pre-filter media layer positioned upstream of the filter media layer 404 as shown in FIG. 4 or a post-filter layer positioned downstream of the filter media layer 404.

In various embodiments, the base layer 402 may also be formed from a polymer (e.g., a melt blown polymer) and may include, for example, a thermoplastic and thermosetting polymer. Suitable polymers may include but are not limited to polyimide, aliphatic polyamide, aromatic polyamide, polysulfone, cellulose acetate, polyether sulfone, polyurethane, poly(ureaurethane), polybenzimidazole, polyetherimide, polyacrylonitrile, poly(ethylene terephthalate), polypropylene, polyaniline, poly(ethylene oxide), poly(ethylene naphthalate), poly(butylene terephthalate), styrene butadiene rubber, polystyrene, poly(vinyl chloride), poly(vinyl alcohol), poly(vinylidene fluoride), poly(vinyl butylene), copolymers or derivative compounds thereof, and combinations thereof.

Following are experimental examples illustrating properties of a Diels-Alder network based polymer FMA-BMA/M2, and an anthracene based polymer AN-MA-nBA that may be used for forming a filter media, for example, using a melt blowing process. These examples are for illustrative purposes and should not be interpreted as limiting the disclosure in any shape or form.

### EXPERIMENTAL EXAMPLES

### Diels Alder Reaction Based Reversible Polymer Network

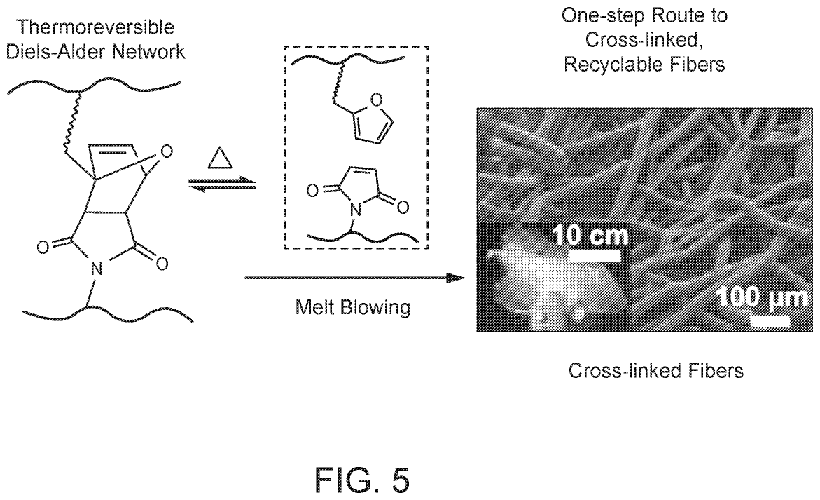

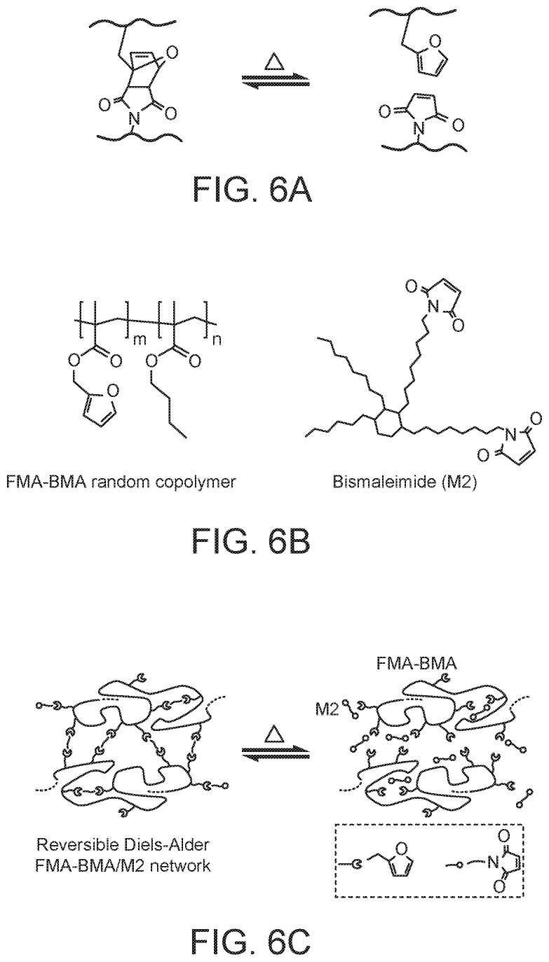

A one-step strategy for producing cross-linked fibers by melt blowing a thermoreversible polymer network with dynamic cross-links is demonstrated herein. Unlike conventional thermosets, reversible networks can undergo dynamic molecular rearrangement reactions to achieve macroscopic flow in response to external stimuli (e.g., heat), exhibiting self-healing capability and reprocessability and recyclability. A thermoreversible network formed by Diels-Alder reaction as shown in FIG. 5 and FIG. 6A was selected for melt blowing into a cross-linked polymer fiber. The Diels-Alder reaction causes a [4+2] cycloaddition between a conjugated diene (e.g., furan) and a dienophile (e.g., maleimide). Below a certain temperature (usually about 100 degrees Celsius), furan-maleimide linkages remain connected and thereby the Diels-Alder network behaves like a thermoset.

At elevated temperatures (>100 degrees Celsius), furan-maleimide linkages break and revert to free furan and maleimide functionalities through retro-Diels-Alder reaction, leading to decross-linked materials with thermoplastic characteristics. Upon heating to a certain temperature, they can achieve an appropriate viscosity for melt blowing. Upon cooling during/after melt blowing, they can undergo Diels-Alder reaction to form cross-linked fibers. These reversibly cross-linked fibers can be recycled because of their dynamic feature, providing sustainability to nonwoven products.

Materials: A thermoreversible furan-maleimide Diels-Alder network was synthesized by mixing a linear copolymer, poly[(furfuryl methacrylate)-co-(butyl methacrylate)] (FMA-BMA copolymer as shown in FIG. 6B and Table I, having pendant furan groups, with a small-molecule bismaleimide (M2; FIG. 6B), followed by curing at room temperature (RT) (FIG. 6C). Furfuryl methacrylate (FMA, 97%) and butyl methacrylate (BMA, 99%) were de-inhibited with basic alumina prior to use. Bismaleimide (M2, BMI-689), 2,2′-Azobis(2-methylpropionitrile) (AIBN, 98%), dichloromethane (≥99.8%), methanol (≥99.8%) were used as received. Toluene was collected from an alumina column. Chloroform-D (CDC13, 99.8%, +0.05 vol % tetramethylsilane) was also used as received.

Typical free radical copolymerization of FMA and BMA: FMA (5.0 g, 0.03 mol) and BMA (24.1 g, 0.17 mol) and AIBN (0.9 g, 0.005 mol) were dissolved in toluene (300 mL, monomer concentration of about 0.7 mol/liter). The solution was purged with argon for about 30 min at RT and then heated to 80 degrees Celsius for reaction. After reaction at 80 degrees Celsius for 48 hours, the solution was concentrated using a rotary evaporator and then added in a dropwise fashion into excess methanol (about 1 liter) under vigorous stirring. FMA-BMA copolymer precipitated out as a white solid, which was then filtered and collected. The obtained FMA-BMA copolymer was purified by dissolution in toluene and precipitation in excess methanol, which was repeated three times to remove residual monomer and initiator. Similarly, FMA-BMA copolymer with a lower molecular weight was synthesized at a higher AIBN concentration (about 11 grams/liter) while keeping everything else the same. The purified FMA-BMA copolymers were dried in a vacuum oven at 100 degrees Celsius for 24 hours prior to use.

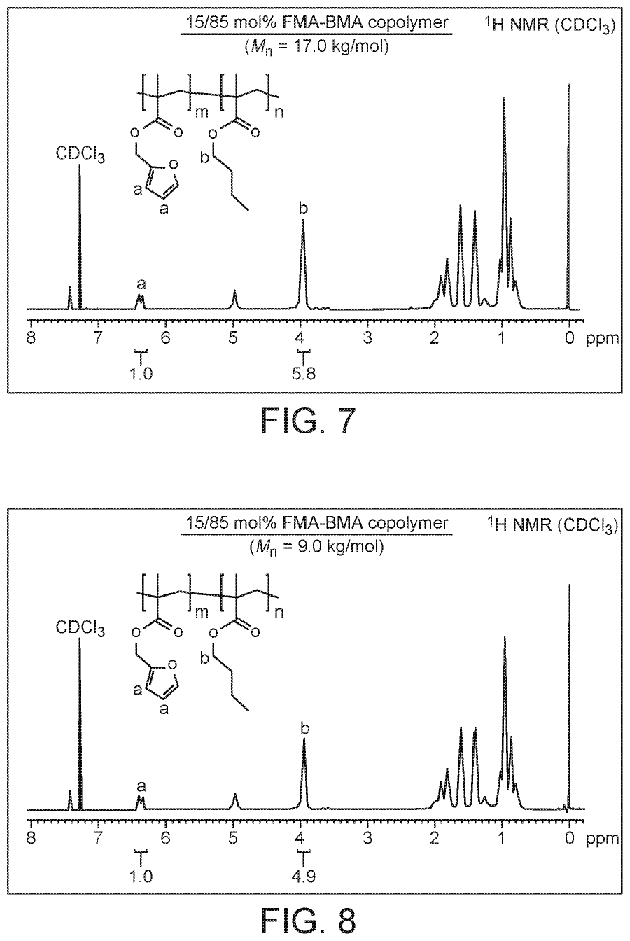

Determination of FMA mole fraction in FMA-BMA copolymer: Dry FMA-BMA copolymers (about 10 mg) were dissolved in CDCl₃ (0.7 mL), and proton nuclear magnetic resonance (¹H NMR) spectra shown in FIGS. 7-8 were characterized using a Bruker AX-400 spectrometer. All resonances were reported as ppm with reference to tetramethylsilane (0 ppm). The average copolymer composition (i.e., mole fractions of FMA and BMA) was calculated based on the total integrated peak areas (obtained from the ¹H NMR spectrum of the FMA-BMA copolymer) for the ═CH—CH═ protons (6.3 ppm) of furan ring in the FMA units and for the —OCH2-protons (3.9 ppm) in the BMA units.

Determination of FMA-BMA copolymer molecular weight: Number-average molecular weight (Mₙ), weight-average molecular weight (M_{w}), and dispersity D (M_{w}/Mₙ) of linear FMA-BMA copolymers were determined by gel permeation chromatography (GPC) analysis, which was performed using an Agilent 1200 system equipped with two Viscotek columns in series, a Wyatt DAWN Heleos II 18-angle laser light scattering (MALS) detector, and a Wyatt OPTILAB T-rEX refractive index detector. GPC samples were analyzed at 50 degrees Celsius in a dimethylformamide mobile phase at a flow rate of 1.0 mL/min. Mₙ, M_{w}, and D were determined with the MALS detector using dₙ/d_{c}=0.0499, as measured by the instrument for linear FMA-BMA copolymers assuming 100% mass elution.

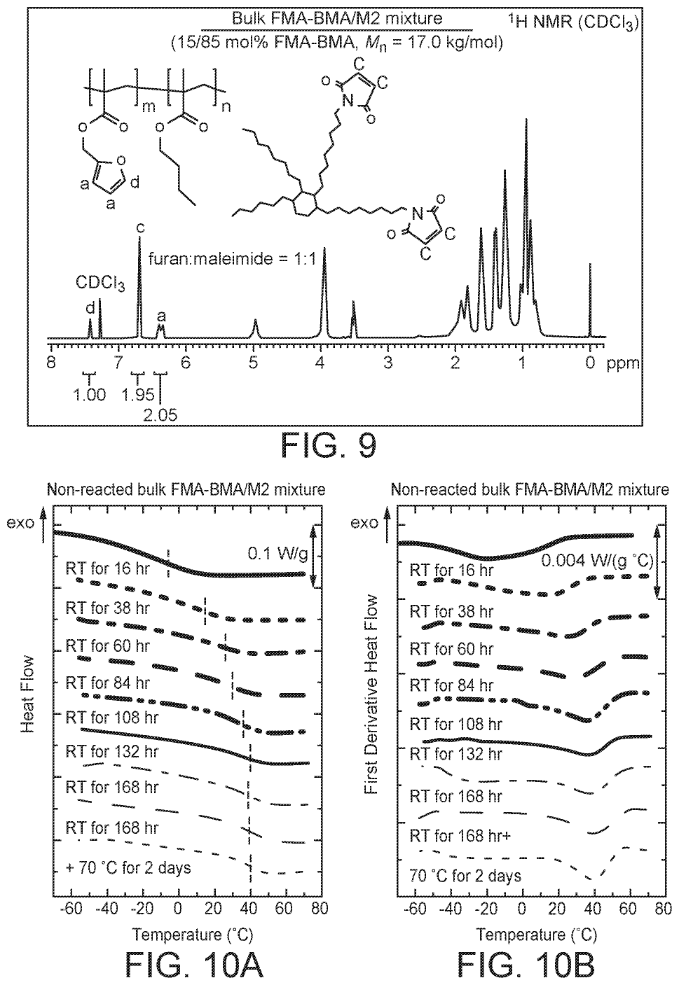

Typical synthesis of bulk FMA-BMA/M2 materials: Linear 15-85 mol % FMA-BMA copolymer with Mn=17.0 kg/mol (3.0 g; containing about 0.003 mol furan groups) and M2 (1.1 g, about 0.003 mol maleimide groups) were co-dissolved in dichloromethane (10 mL) at RT. The obtained homogeneous solution was freeze dried, resulting in a non-reacted bulk FMA-BMA/M2 mixture with furan:maleimide=1:1 (i.e., stoichiometric balance between furan and maleimide functional groups). The stoichiometric balance between furan and maleimide functional groups in this non-reacted bulk FMA-BMA/M2 mixture was confirmed by its ¹H NMR spectrum shown in FIG. 9. The obtained non-reacted bulk FMA-BMA/M2 mixture was then cured at RT for various amounts of time (up to 1 week). Two other bulk FMA-BMA/M2 mixtures, with either a lower molecular weight FMA-BMA copolymer or a different furan:maleimide ratio, were prepared in a similar manner and cured at RT.

Gel fraction determination by swelling tests: Swelling tests were performed to obtain the gel fraction values of the cross-linked FMA-BMA/M2 materials. In a typical swelling test procedure, the cross-linked material was put into dichloromethane and left to swell for 1 day. The solution was then separated from the swollen solid material, and more fresh dichloromethane was added afterwards. This procedure was repeated seven times (to ensure an equilibrium state) before drying the swollen solid material. By comparing the weights of the dried swollen solid material and the original material, the gel fraction was determined.

Differential scanning calorimetry (DSC): Differential scanning calorimetry was done with a Mettler Toledo DSC 1 instrument. Approximately 5 mg of sample was loaded into hermetically sealed aluminum pans for each DSC run. Materials were heated to 50 degrees Celsius to erase thermal history, cooled to −60 degrees Celsius (or −80 degrees Celsius in some cases) at 20 degrees Celsius/min, and heated to 70 degrees Celsius at 10 degrees Celsius per min. Certain samples were heated to a higher temperature, e.g., 162 degrees Celsius, to examine the Diels-Alder and/or retro-Diels-Alder reactions during the heating process. Glass transition temperatures (T_{g}, ½ΔCp from DSC) were obtained from the second heating ramp; first derivative heat flow curves were also obtained by differentiating the heat flow curves as shown in FIG. 10.

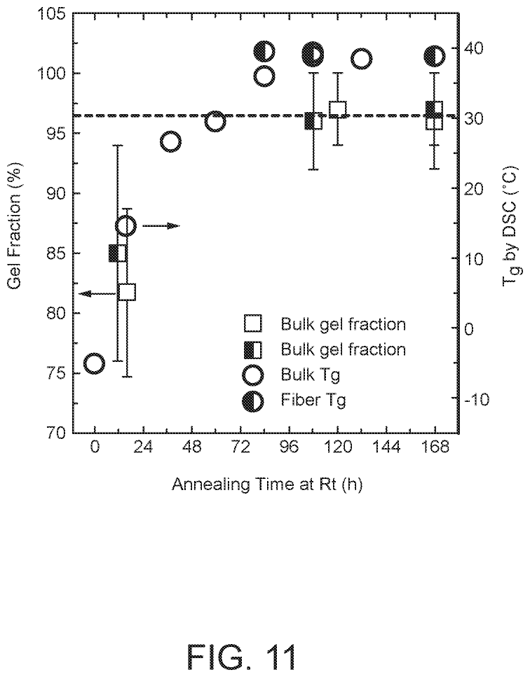

FIG. 11 shows the evolution of gel fraction (from swelling tests) and T_{g} (T_{g}, ½ΔCp from differential scanning calorimetry, DSC) with annealing time at RT for bulk FMA-BMA/M2 mixture. The FMA-BMA/M2 mixture hereafter consists of 15-85 mol % FMA-BMA copolymer (Mn=17 kg/mol) and M2 with a stoichiometric balance between furan and maleimide groups (confirmed by proton nuclear magnetic resonance, ¹H NMR;33 Supporting Information). At 0 hour, the nearly unreacted FMA-BMA/M2 mixture was soluble in dichloromethane. At 16 hours, the partially-reacted sample was insoluble in dichloromethane and had a gel fraction of 82(±7)%, indicative of network formation. After about 120 hours, the gel fraction reached a plateau value of 97(±3)%, indicating that the bulk FMA-BMA/M2 mixture reached full gel state (within experimental error).

TABLE I
FMA-BMA copolymer synthesized by
free radical copolymerization.

| Synthesized | Mₙ | Ð | FMA mol % in | Tg (±1 degrees |
|---|---|---|---|---|
| copolymer | (kg/mol) | (M_{w}/Mₙ) | copolymer | Celsius) |
| 15-85 mol % | 17.0 | 1.5 | 14.5 | 27.5 |
| FMA-BMA | | | | |

According to FIG. 11 glass transition temperature (T_{g}) of the bulk FMA-BMA/M2 mixture initially increased over time due to the formation of furan-maleimide linkages which slows down the chain mobility. After about 100 h, T_{g} reached a plateau value of about 39 degrees Celsius. This indicates that the bulk FMA-BMA/M2 mixture achieved an equilibrated state at RT, consistent with gel fraction results. It should be appreciated that the Diels-Alder reaction rate can be accelerated by controlling curing temperature, e.g., the time required to reach equilibrium can decrease from about 100 hours at RT to less than 1 hour at 60 degrees Celsius. The final network T_{g} is about 10 degrees Celsius higher than that of linear FMA-BMA precursor (T_{g} approximately 28 degrees Celsius) because of cross-linking. Additionally, the glass transition of FMA-BMA/M2 is relatively broad indicative of heterogeneous dynamics within the network.

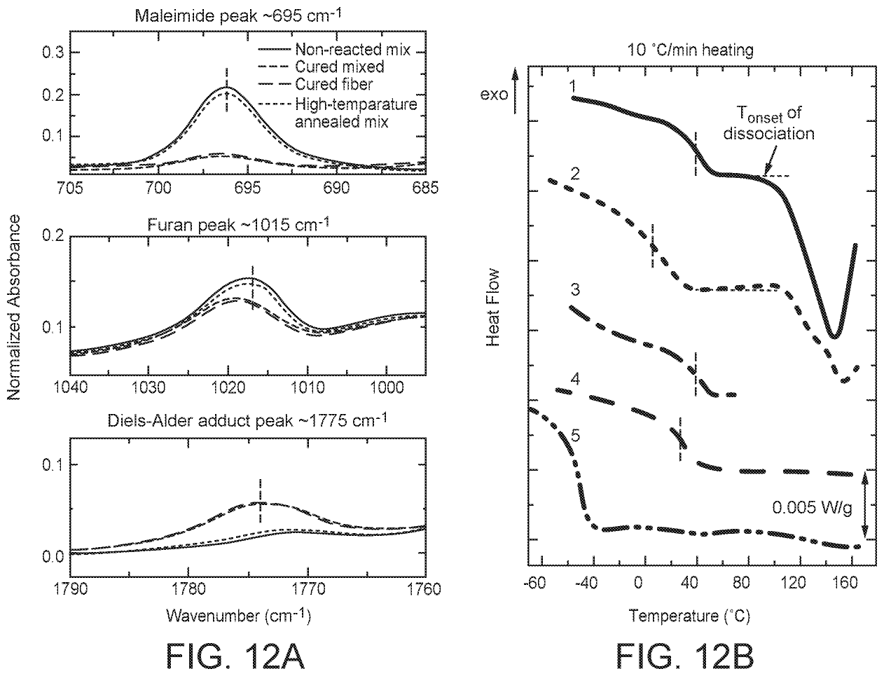

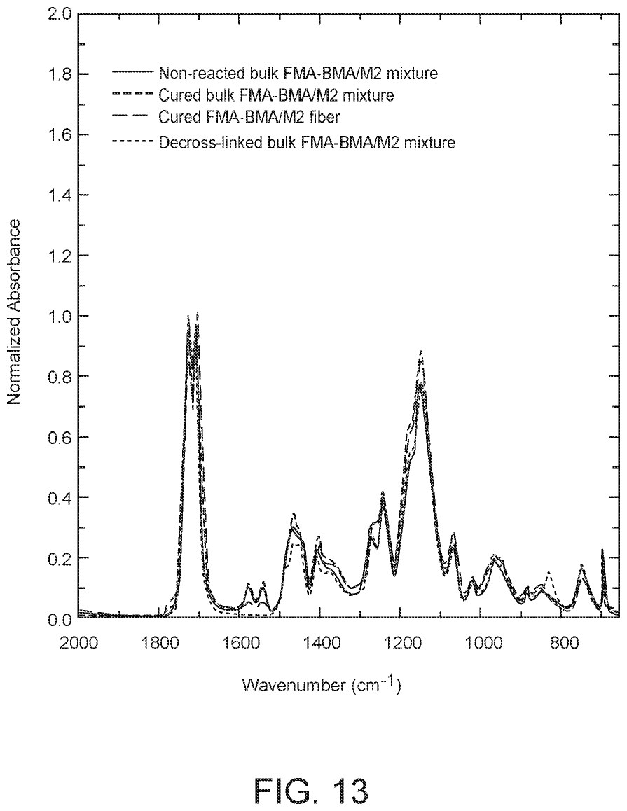

Fourier transform infrared spectroscopy (FTIR): The Diels-Alder reaction between furan and maleimide was confirmed by FTIR as shown in FIG. 12A. The Diels-Alder reaction between maleimide and furan was investigated using attenuated total reflection Fourier transform infrared spectroscopy (ATR-FTIR; Nicolett 6700, Thermo Scientific). All samples (both bulk FMA-BMA/M2 materials and corresponding fibers) were scanned at a resolution of 2 cm⁻¹, and 64 scans were collected in the range of 4000-600 cm⁻¹. After reaction at RT for a sufficient amount of time, absorption peaks corresponding to maleimide (about 695 cm⁻¹) and furan (about 1015 cm⁻¹) of the initial bulk FMA-BMA/M2 mixture decreased. Additionally, a new peak at 1775 cm⁻¹ specific to Diels-Alder adducts of furans and maleimides was observed for the reacted material (FIGS. 12A and 13), indicating that the Diels-Alder reaction actually took place between maleimide and furan functionalities. To account for variations in sample thickness among experiments, the area under maleimide and furan peaks were self-referenced to the area under the carbonyl peak (about 1725 cm⁻¹). Quantitative conversion of the stoichiometric reaction between maleimide and furan functionalities was determined by the decrease in self-referenced maleimide peak area at time t (Aₜ) from the initial self-referenced peak area (A₀), A₀-Aₜ, relative to the initial self-referenced peak area A₀ (i.e., conversion=(A₀-Aₜ)/A₀).

A comparison between the FTIR spectra of non-reacted and cured FMA-BMA/M2 mixtures shows that after curing both furan (about 1015 cm⁻¹; ring breathing) and maleimide (about 695 cm⁻¹, ═C—H bending) peaks decreased whereas a new peak (about 1775 cm⁻¹) specific to furan-maleimide adducts appeared, confirming the Diels-Alder reaction between furan and maleimide. The final conversion of the stoichiometric furan-maleimide reaction at RT was determined to be about 85%. The final conversion is mainly dictated by the thermodynamic equilibrium constant of Diels-Alder reaction. Cross-linking may also limit chain mobility and topologically hinder furan and maleimide groups from finding each other to undergo further reaction.

The thermoreversibility of furan-maleimide networks was tested by DSC and FTIR. When the cured FMA-BMA/M2 network was heated, the DSC heat flow curve (curve 1 in FIG. 12B) showed an endothermic peak starting at about 90 degrees Celsius which decreased until about 145 degrees Celsius corresponding to the dissociation of furan-maleimide linkages (or decross-linking) through retro-Diels-Alder reaction. The cured network was then annealed at 162 degrees Celsius for 15 min, and the annealed sample (curve 2 in FIG. 12B) showed a decreased T_{g}. This confirms that the annealed sample underwent decross-linking. The recovery of furan and maleimide moieties in this sample was confirmed by FTIR (FIG. 12A). Additionally, curve 2 showed a small exothermic peak starting at about 70 degrees Celsius (prior to endothermic dissociation process). This is because some disconnected furan and maleimide groups can reconnect upon heating. The high-temperature annealed sample was then left at RT for another about 120 hours, and it reached the same T_{g} (curve 3 in FIG. 12B) as the originally cured FMA-BMA/M2 network, confirming the robust thermoreversibility of furan-maleimide network. Such excellent reversibility is attributed to the selection of furan and maleimide which allows retro-Diels-Alder reaction to occur without significant side reactions. Curves 4 and 5 in FIG. 12B confirmed that FMA-BMA and M2 underwent little to no side reactions.

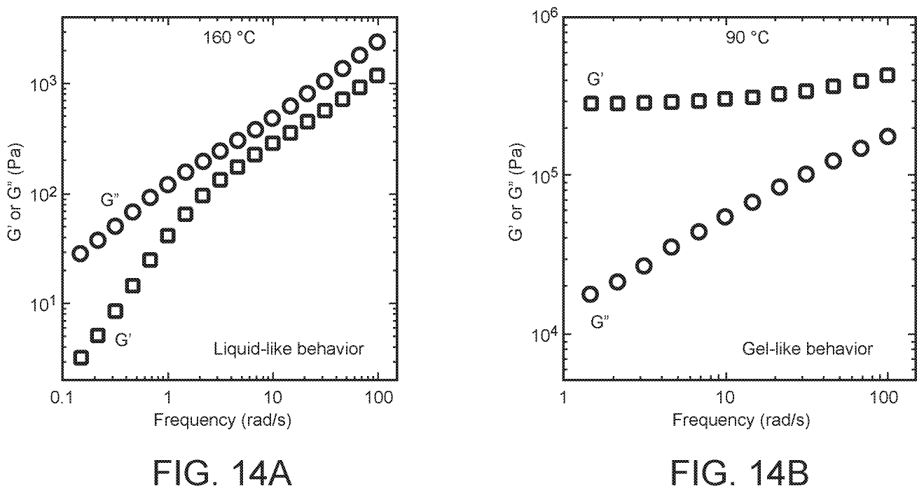

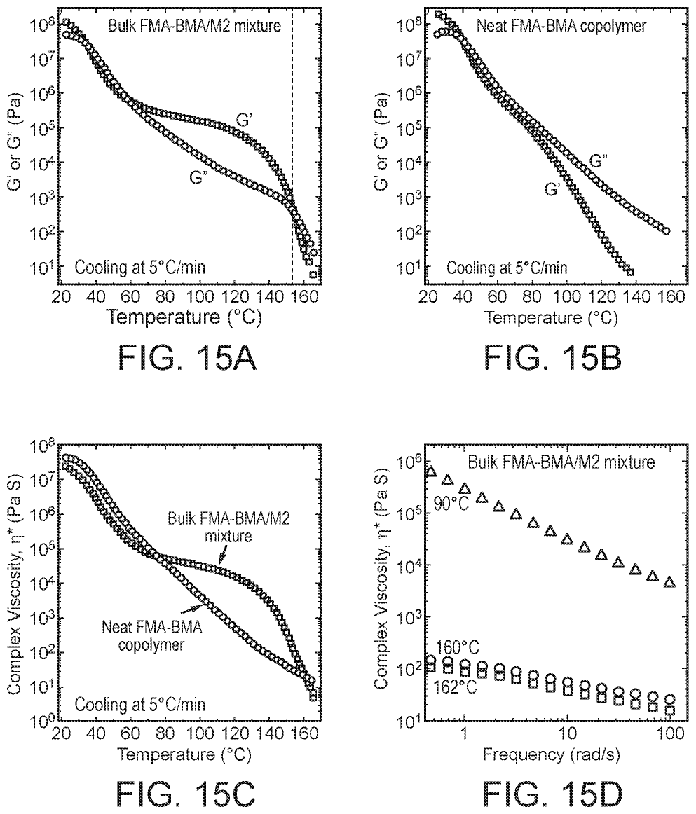

Rheological measurements: FIG. 14A-B are plots of elastic (G′) and viscous (G″) modulus versus frequency for bulk FMA-BMA/M2 mixture (15-85 mol % FMA-BMA copolymer with Mₙ=17.0 kg/mol; furan:maleimide=1:1) at 160 degrees Celsius (FIG. 14A) and 90 degrees Celsius (FIG. 14B). FIGS. 15A and 15B show the elastic (G′) and viscous (G″) moduli versus temperature when cooling from about 160 degrees Celsius for FMA-BMA/M2 mixture and FMA-BMA alone, respectively (M2 is a liquid at RT and cannot generate enough torque for proper measurements at higher temperatures). Rheological measurements were performed to verify the melt processability of thermoreversible furan-maleimide networks. Rheological properties were measured with a strain-controlled ARES rheometer (TA Instrument) equipped with either a 25 mm (for isothermal dynamic frequency sweep experiments; FIGS. 14A-B) or 8 mm (for non-isothermal dynamic temperature sweep experiments; FIGS. 15A-C) parallel-plate fixture. All experiments were performed in the linear viscoelastic regions of the polymers, which were determined by dynamic strain sweeps. Non-isothermal dynamic temperature sweeps were conducted under a frequency of 5 rad/s to measure elastic modulus (G′), loss modulus (G″), and complex viscosity (η*) (FIGS. 15A-C) as a function of temperature during a 5 degrees Celsius/min cooling scan. Isothermal dynamic frequency sweeps measurements were conducted between 0.1 and 100 rad/s to measure the G′, G″, and η* as a function of frequency at different temperatures (FIGS. 14A-B).

According to FIG. 15A, G″>G′ for FMA-BMA/M2 mixture at higher temperatures (>about 152 degrees Celsius), characteristic of a liquid-like sol; additionally, frequency sweep experiments at 160 degrees Celsius confirmed that the moduli exhibited liquid-like scaling at low frequency. Thus, at higher temperatures, bulk FMA-BMA/M2 sample is in the decross-linked state, allowing for melt processing.

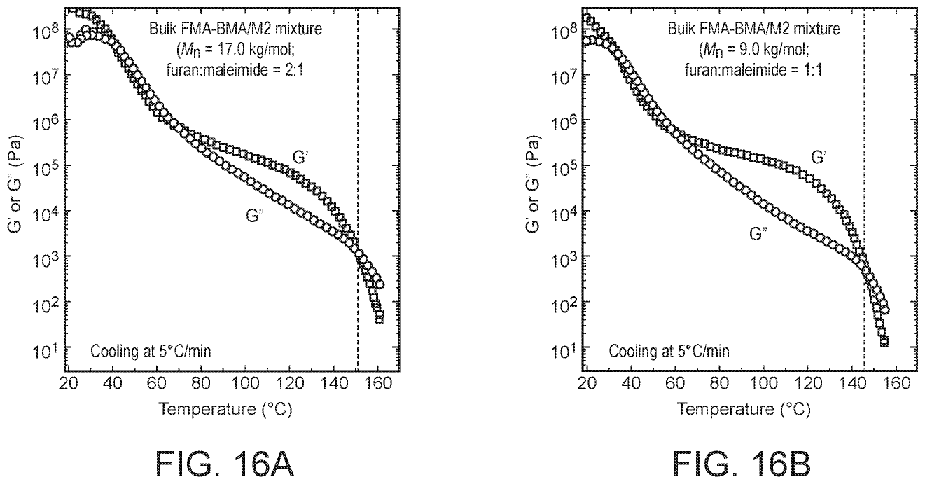

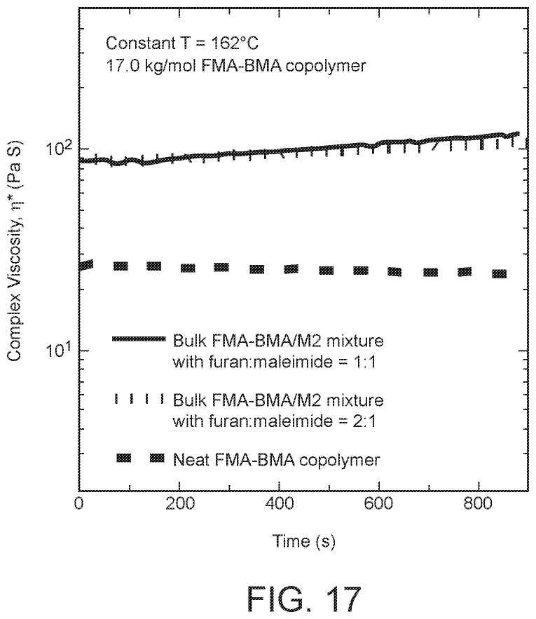

FIG. 16A-B are plots of G′ and G″ moduli versus temperature for bulk FMA-BMA/M2 mixture with 17.0 kg/mol FMA-BMA and furan:maleimide=2:1 (FIG. 16A) and bulk FMA-BMA/M2 mixture with 9.0 kg/mol FMA-BMA and furan:maleimide=1:1 (FIG. 16B). FIG. 17 are plots of complex viscosity η* versus annealing time at 162 degrees Celsius for bulk FMA-BMA/M2 mixture with furan:maleimide=1:1 (solid line) and furan:maleimide=2:1 (dotted line) as well as neat FMA-BMA copolymer (dashed line). Mₙ=17.0 kg/mol for the FMA-BMA copolymer here.

Upon cooling, G′ increased faster than G″, and a cross-over in G′ and G″ was observed at about 152 degrees Celsius. The cross-over temperature, T_{cross-over}, is usually taken as the gel point or solidification point. It should be appreciated that T_{cross-over} is different from Tₒₙₛₑₜ (about 100 degrees Celsius) for the dissociation of furan-maleimide linkages. T_{cross-over} is dictated by a combination of thermodynamic equilibrium conversion and gel point conversion, both of which depend on polymer/network structures. For example, T_{cross-over} of FMA-BMA/M2 was lowered by decreasing the FMA-BMA molecular weight (FIGS. 16A-B). Below T_{cross-over}, G′ entered a rubbery plateau between about 110 and about 70 degrees Celsius. Frequency sweep of the FMA-BMA/M2 sample at 90 degrees Celsius demonstrated a G′ plateau at low frequency, characteristic of a solid-like gel (FIGS. 16A-B). In contrast, linear FMA-BMA copolymer showed liquid-like behavior in the rubbery state, without a T_{cross-over} (FIG. 15B) above T_{g}. These results indicate that upon cooling the thermodynamic equilibrium shifts towards Diels-Alder reaction, leading to a sol-gel transition when enough furan-maleimide linkages are formed to cross-link the FMA-BMA/M2 sample.

As shown in FIG. 15C, during the sol-gel transition, complex viscosity η* of the FMA-BMA/M2 sample exhibited a dramatic (>3 orders of magnitude) increase within a relatively narrow temperature range (e.g., η*≈10 Pa S at about 160 degrees Celsius and η* >10⁴ Pa·S at about 125 degrees Celsius). In contrast, FMA-BMA copolymer showed a gradual η* increase within the same temperature range. The dramatic increase in η* for the bulk FMA-BMA/M2 sample is due to the formation of network structures upon cooling, which greatly hindered chain motion in the rubbery state. This is analogous to the crystallization process in semi-crystalline polymers, during which the formation of immobile crystalline regions greatly reduces chain mobility and thereby dramatically increase the viscosity of the system. (Crystallization is a common solidification mechanism for melt blown fibers). Therefore, thermoreversible furan-maleimide networks should be suitable for melt blowing. At higher temperatures, the material is in the decross-linked state and has a relatively low viscosity, allowing for extrusion and fiber attenuation. Upon cooling during/after melt blowing, the viscosity increases dramatically, leading to fiber solidification. This provides a new solidification mechanism for melt blown fibers via reactive cross-linking, distinguishing itself from conventional solidification caused by glass transition or crystallization.

Melt blowing: To produce nonwoven fibers, cured FMA-BMA/M2 materials were loaded into a custom-built lab-scale melt blowing apparatus, which was constructed by fitting a homemade melt blowing die and fiber collector to a commercial capillary rheometer (GOETTFERT® Rheo-Tester 1500). The capillary rheometer was used to heat the polymer up to the melt blowing temperature (e.g., 162 degrees Celsius for the bulk FMA-BMA/M2 material with 17 kg/mol FMA-BMA and furan:maleimide=1:1) and extrude the polymer through a single-hole melt blowing die with an orifice diameter of 0.2 mm at a controlled polymer flow rate (e.g., about 0.4 or 0.2 g/(min hole)). Melt blowing was carried out 5 minutes after the sample reached the melt blowing temperature (heating performed for about 5 minutes). The air flow rate was 3.8 cubic feet per minute (SCFM) and the air pressure at the die exit was about 5 psi. Throughout the melt blowing process, T_{polymer}=T_{die}=T_{air at die exit}. Melt blown fibers were collected using a stationary collector consisting of a stainless steel screen covered with aluminum foil. All fibers were cured at RT for 5 days before characterization.

To optimize melt blowing conditions, frequency experiments were performed. FIG. 15D shows η* versus frequency (equivalent to the steady shear viscosity versus steady shear rate by the Cox-Merz rule) at different temperatures for bulk FMA-BMA/M2 sample. Zero-shear rate viscosity (η₀) at 162 degrees Celsius is estimated to be about 100 Pa S, suitable for melt blowing. Additionally, when the sample was annealed at 162 degrees Celsius, η* exhibited limited increase over time (about 8% increase after about 15 min (FIG. 17)). Hence, the viscosity can remain relatively constant during melt blowing which can be performed in a short time period, e.g., <15 min). Melt blowing experiments were thereby performed at 162 degrees Celsius, and the resulting fibers were cured at RT for 5 days before characterization.

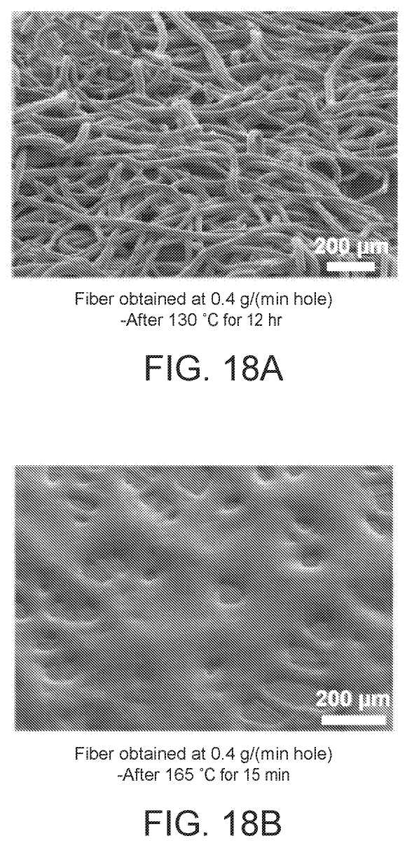

FIGS. 18A-B are representative SEM images of the melt blown FMA-BMA/M2 fibers obtained at 0.4 gram/(min hole) polymer flow rate after annealing (FIG. 18A) at 130 degrees Celsius for 12 hours and (FIG. 18B) 165 degrees Celsius for 15 min. Cross-linking of the cured FMA-BMA/M2 fibers was confirmed by their insolubility in dichloromethane at RT. The cured fibers showed within error the same gel fraction, T_{g}, and conversion as those for the bulk FMA-BMA/M2 sample cured at RT (FIGS. 11 and 12A), consistent with the robust thermoreversibility of such Diels-Alder networks.

Fiber diameter determination by scanning electron microscope (SEM): Melt blown fibers were cured at RT for 5 days and then coated with about 5 nm iridium using an ACE600 Coater. For each fiber mat, 10-20 SEM micrographs were taken with a Hitachi S-4700 SEM and 200-300 fiber diameter measurements were made using ImageJ software. The OriginLab (a data analysis software package) was employed to fit a normal (or Gaussian) distribution function (Equation 1) to the fiber diameter data. The geometric average (dₐᵥ) and standard deviation (SD; a) of the fiber diameter distribution were extracted from the normal fitting according to the following equation:

$$f ( d ) = x = \frac{1}{σ \sqrt{2 π}} exp [ - \frac{{( d - {d}_{a v} )}^{2}}{2 {σ}^{2}} ] \qquad ( 1 )$$

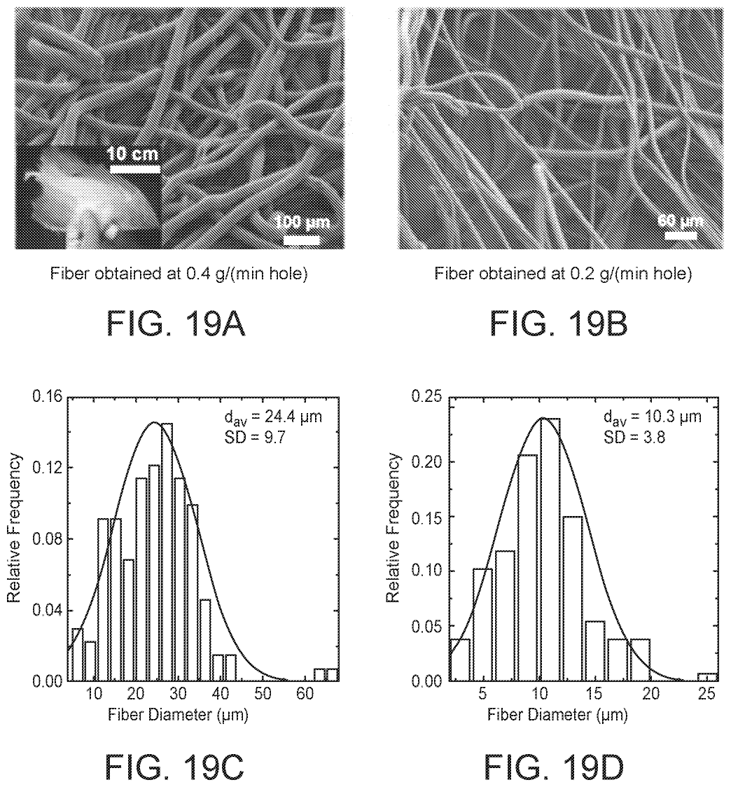

The melt blown mats (FIG. 19A inset) exhibited a relatively uniform fiber morphology (without fused fibers), as demonstrated by representative scanning electron microscope (SEM) images in FIG. 19A and 19B. The average diameter day was determined by applying a normal or Gaussian fit to the fiber diameter distribution (FIG. 19C and 19D). A comparison between FIG. 19C and 19D indicates that dₐᵥ can be controlled by tuning polymer flow rate, e.g., day decreased from 24.4 to 10.3 μm by decreasing the polymer flow rate from 0.4 to 0.2 g/(min·hole).

The fiber morphology of the FMA-BMA/M2 mat was nearly unchanged after annealing at 130 degrees Celsius (below T_{cross-over} in FIG. 15A) for 12 hours since the fibers remained in the gel state at 130 degrees Celsius. After annealing at 165 degrees Celsius (above T_{cross-over} in FIG. 15A) for 15 min, however, the fiber morphology was converted to a droplet morphology. This demonstrates that these reversibly cross-linked fibers can be reprocessed and recycled (into secondary fibers or other shapes) because of their dynamic nature, providing sustainability to conventional cross-linked fibers.

Thus, the above experiments demonstrate a one-step strategy for producing cross-linked fibers by melt blowing thermoreversible Diels-Alder polymer networks. Significantly, this is a versatile technique, applicable to any reversible network that can undergo decross-linking or molecular rearrangement reactions to induce macroscopic flow for melt blowing. Such reversible networks can be easily obtained by incorporating dynamic cross-links into commodity feedstock polymers (e.g., methacrylates, styrenes, etc.), as demonstrated here. These reversible networks possess melt processability and can be melt blown into cross-linked, yet recyclable, polymer fibers.

### Anthracene-Dimerization Reaction Based Reversible Polymer Network

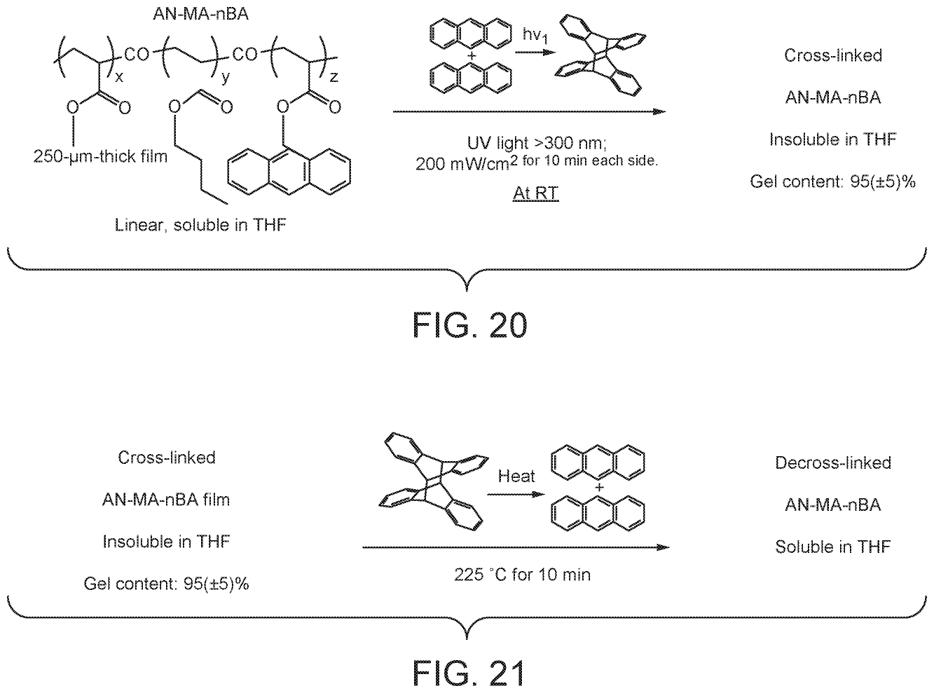

AN-MA-nBA copolymer was used as an example of an anthracene-dimerization reaction based reversible polymer network which can be melt blown to form a polymer fiber layer which may be used as a filter media layer. As shown in FIG. 20, uncross-linked AN-MA-nBA is in liquid state and cross-links via anthracene linkages when exposed to UV light. In an uncross-linked state the polymer is linear, is soluble in tetrahydrofuran (THF) and can form a 250 micron thick film. Uncross-linked AN-MA-nBA polymer is exposed to UV light having a wavelength of greater than 300 nm and a power of 200 mW/cm² for 10 minutes on each side of the polymer film to obtain the cross-linked AN-MA-nBA polymer which has a gel content of 95±5% and is insoluble in THF.

The cross-linked AN-MA-nBA polymer can be decross-linked by heating to about 225 degrees Celsius for a predetermined annealing time (10 minutes) as shown in FIG. 21. At this temperature the anthracene-dimer linkages forming the polymer break such that the AN-MA-nBA liquefies and is again soluble in THF.

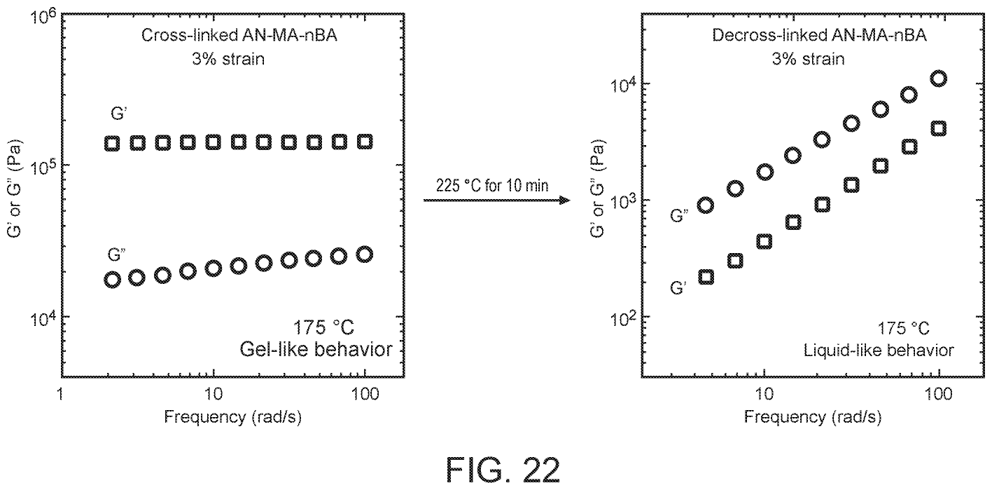

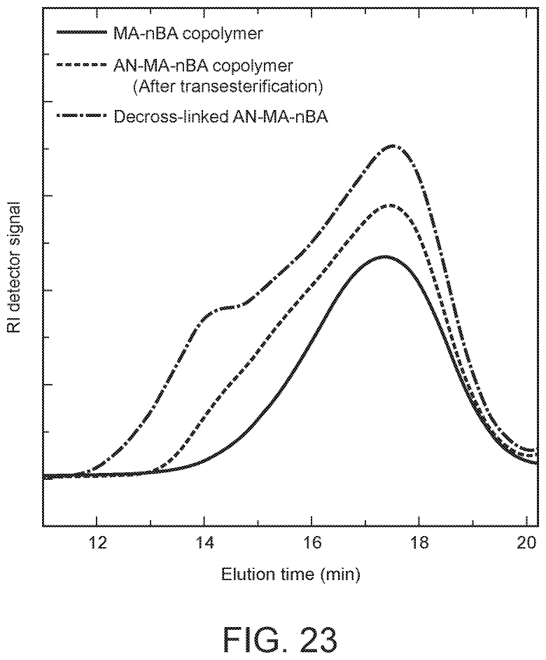

FIG. 22 are plots of G′ or G″ at various frequencies for cross-linked and decross-linked AN-MA-nBA polymer. Crosslinked AN-MA-nBA exhibits gel like behavior at 175 degrees Celsius, while decross-linked AN-MA-nBA exhibits liquid like behavior at 175 degrees Celsius. FIG. 23 are plots of size exclusion chromatograph (SEC) of AN-MA-nBA monomers and polymers with dimethylformamide (DMF) as eluent. As observed from the SEC analysis, decross-linked AN-MA-nBA contains branched AN-MA-nBA chains. Table II lists the molecular weight (Mₙ), weight-average molecular weight (M_{w}), and dispersity D (M_{w}/Mₙ) of MA-nBA polymer, AN-MA-nBA polymer and decross-linked AN-MA-nBA polymer.

TABLE II
Mₙ, M_{w} and Ð of MA-nBA polymer, AN-MA-nBA
polymer and decross-linked AN-MA-nBA polymer.

| | Mₙ | M_{w} | Ð |
|---|---|---|---|
| Polymer | (kg/mol) | (kg/mol) | (Mₙ/M_{w}) |
| MA-nBA | 16.0 | 33.5 | 2.1 |
| AN-MA-nBA | 32.0 | 83.0 | 2.6 |
| Decross-linked | 68.0 | 313.0 | 4.6 |
| AN-MA-nBA | | | |

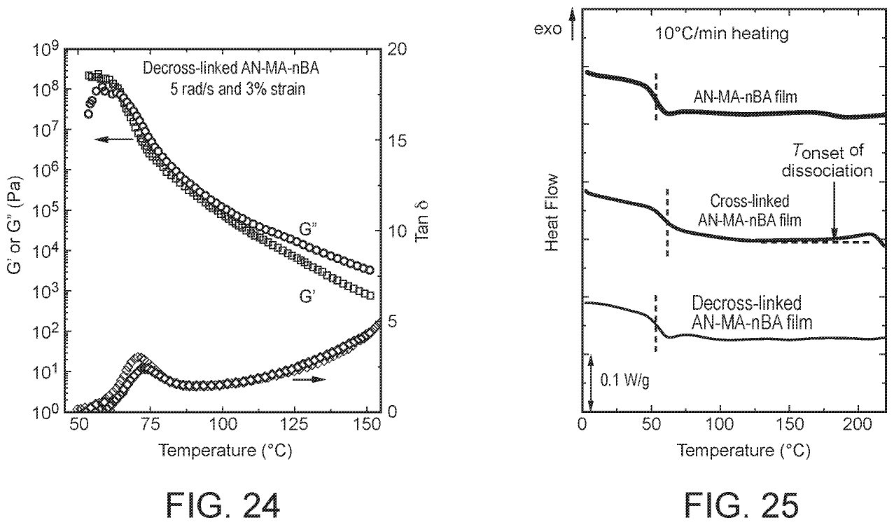

FIG. 24 are plots of G′ or G″ of a decross-linked AN-MA-nBA copolymer film. These rheological measurements confirmed the decross-linking of the AN-MA-nBA copolymer due to heating at 225 degrees Celsius for 10 minutes. FIG. 25 are plots of differential scanning calorimetry (DSC) of AN-MA-nBA films, cross-linked and decross-linked polymer. Decross-linking was performed at a heat ramp rate of 10 degrees Celsius/minute. Decross-linking and cross-linking reversibility were confirmed by the DSC measurements.

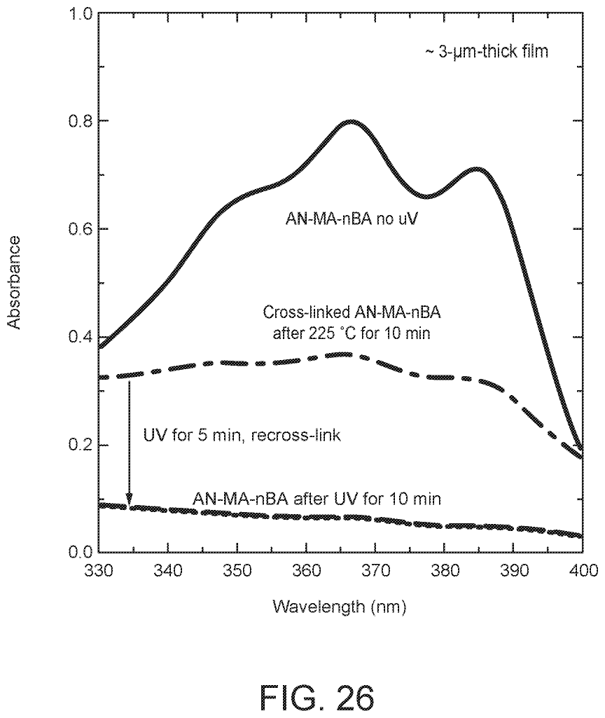

FIG. 26 are plots of absorbance vs wavelength showing reversibility of AN-MA-nBA copolymer networks. A 3 micron thick cross-linked AN-MA-nBA has minimum UV absorption. The film is decross-linked via heating at 225 degrees Celsius for 10 minutes. The decross-linked AN-MA-nBA recross-links when exposed to UV light for 10 minutes as observed by its insolubility and diminished anthracene peaks.

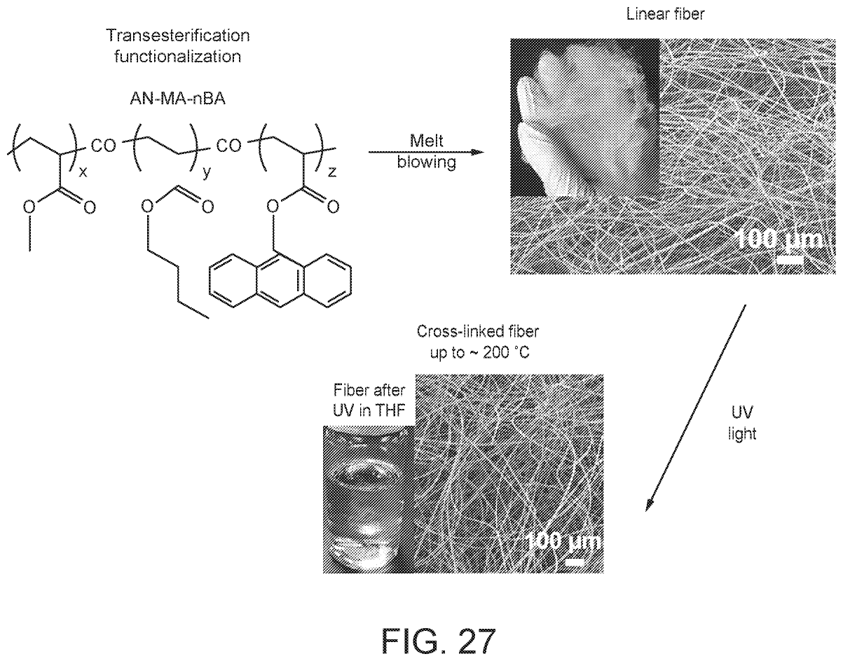

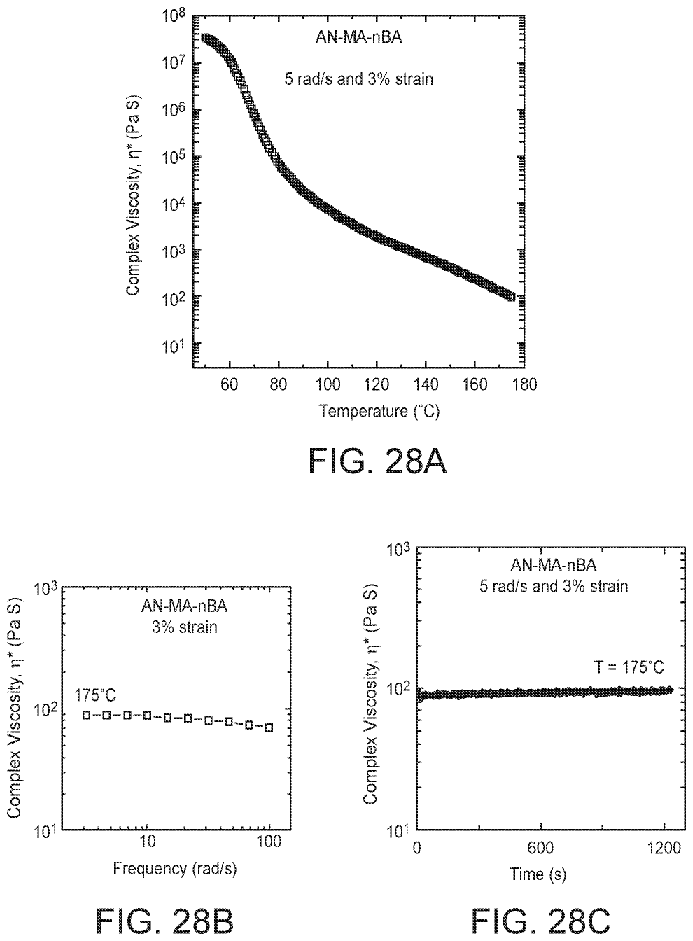

FIG. 27 shows a process for melt blowing an anthracene liquefied polymer and then UV cross-linking the polymer to form a non-woven polymer fiber network. FIGS. 28A-C are plots of viscosity of AN-MA-nBa polymer at various temperatures, frequencies and times at 175 degrees Celsius temperature. Viscosity is stable at 175 degrees Celsius for at least 20 minutes which is suitable for melt blowing.

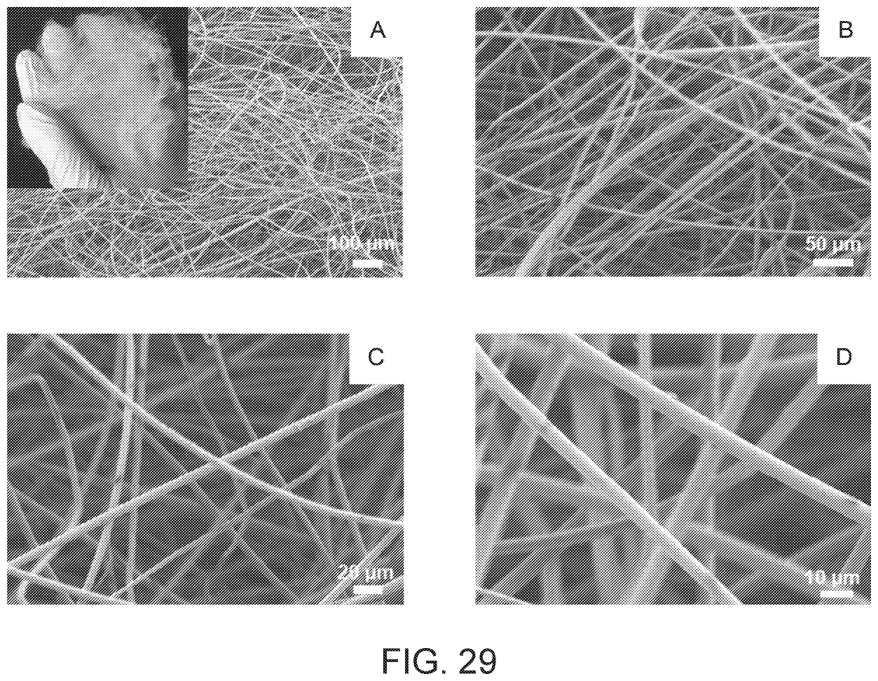

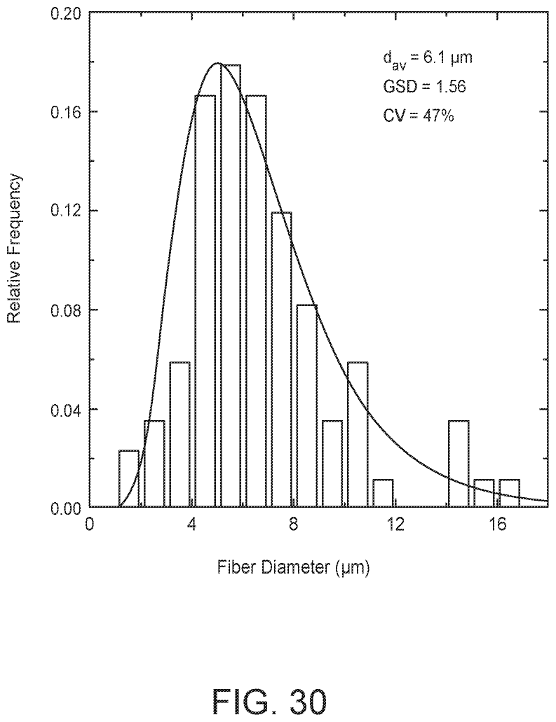

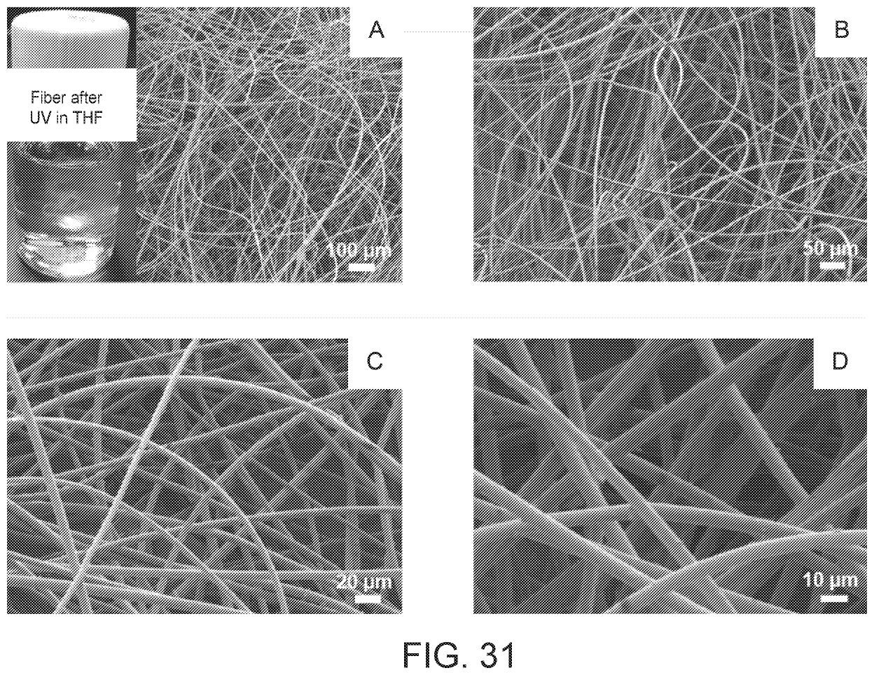

FIG. 29A-D are scanning electron micrograph (SEM) images of the melt blown linear AN-MA-nBA polymer fibers before UV cross-linking. FIG. 30 is a bar graph of relative frequency vs fiber diameter of melt blown AN-MA-nBA polymer fibers of FIGS. 29A-D. Average fiber diameter was 6.1 microns with a SD of 1.56 and coefficient of variation (CV) of 47%.

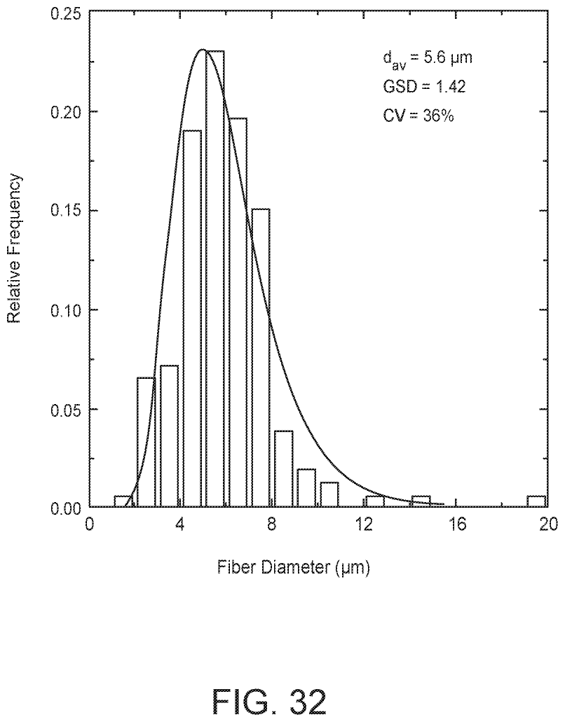

FIGS. 31A-D are SEM images of the melt blown linear AN-MA-nBA polymer fibers after UV crosslinking. FIG. 32 is a bar graph of frequency vs fiber diameter of melt blown AN-MA-nBA polymer fiber networks of FIGS. 31A-D. Average fiber diameter was 5.6 microns with a SD of 1.42 and coefficient of variation (CV) of 36%.

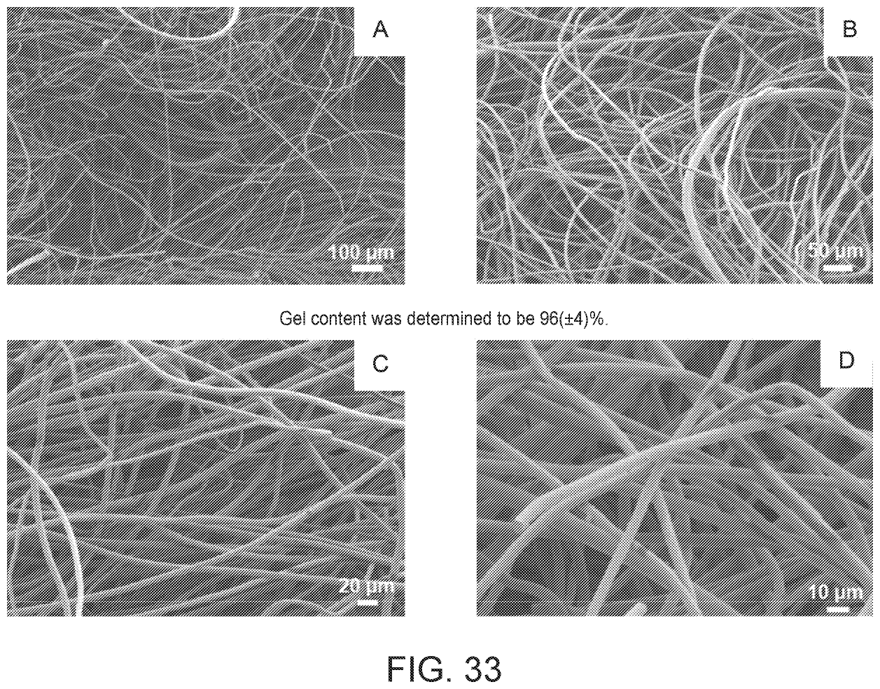

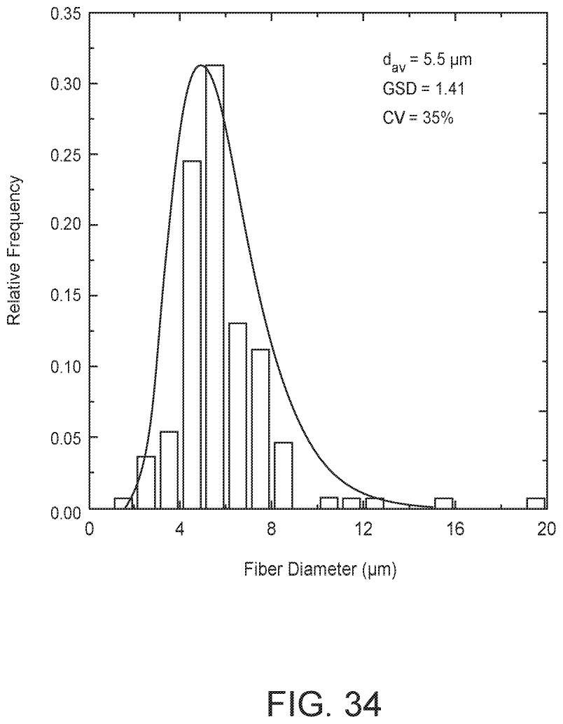

FIGS. 33A-D are SEM images of melt blown AN-MA-nBA polymer fibers after UV cross-linking THF swelling and drying. FIG. 34 is a bar graph of relative frequency vs fiber diameter of melt blown AN-MA-nBA polymer fiber networks of FIGS. 33A-D. Average fiber diameter was 5.5 microns with a SD of 1.41 and coefficient of variation (CV) of 35%.

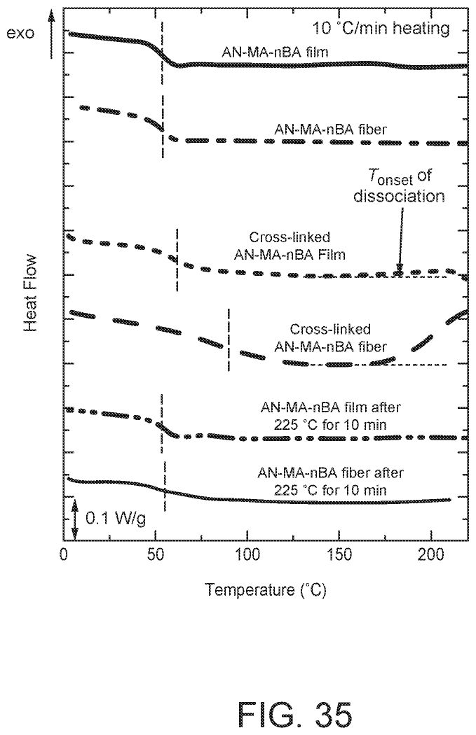

FIG. 35 is a plot of thermal properties of AN-MA-nBA films and fibers at various states. After similar UV light exposure, cross-linked AN-MA-NBA fiber (about 5-6 microns) shows a greater T_{g} than that of cross-linked film (about 250 μm). Higher cross-link density in cross-linked AN-MA-NBA film and fiber exhibit similar T_{g} values after annealing at 225 for 10 min.

As used herein, the singular forms “a,” “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method, comprising:
providing a polymer;
heating the polymer to a first predetermined temperature so as to liquefy the polymer;
forming the liquefied polymer into a polymer fiber; and
cross-linking the polymer fiber to form a cross-linked polymer fiber comprising a polymer network by at least one of cooling the polymer fiber to a second predetermined temperature lower than the first predetermined temperature or exposing the polymer fiber to a cross-linking stimulus, the cross-linked polymer fiber capable of being decross-linked by heating to a third predetermined temperature above a characteristic decross-linking temperature of the polymer.

2. The method of claim 1, further comprising:
cooling the polymer fiber to a solidification temperature prior to cross-linking the polymer fiber so as to at least partially solidify the liquefied polymer.

3. The method of claim 1, wherein providing the polymer comprises providing a cross-linked polymer, and wherein heating the polymer to the first predetermined temperature decross-links the polymer, thereby forming the liquefied polymer.

4. The method of claim 1, wherein the polymer network comprises one of Diels-Alder linkages, anthracene-dimer linkages, alkoxyamine linkages, or cinnamyl linkages.

5. The method of claim 4, wherein the polymer is formulated such that the polymer network comprises Diels-Alder linkages formed upon cooling the polymer fiber to the second predetermined temperature.

6. The method of claim 5, wherein the polymer comprises poly[(furfuryl methacrylate)-co-(butyl methacrylate)] (FMA-BMA) copolymer and a bismaleimide (M2) monomer cross-linked via furan-maleimide linkages generated by a Diels-Alder reaction.

7. The method of claim 4, wherein the polymer is formulated such that the polymer network comprises anthracene-dimer cross-linkages formed in response to exposing the liquid polymer fiber to the cross-linking stimulus.

8. The method of claim 7, wherein the cross-linking stimulus includes one of ultra violet light or sun light.

9. The method of claim 1, wherein the liquefied polymer is formed into the polymer fiber by melt blowing, 3D printing, spray printing, spin coating or casting.

10. A method, comprising:
disposing a polymer into a melt blowing die;
heating the polymer to a first predetermined temperature in the melt blowing die so as to liquefy the polymer;
extruding the liquefied polymer through an orifice of the melt blowing so as to form a polymer fiber; and
cross-linking the polymer fiber to form a cross-linked polymer fiber comprising a polymer network by at least one of cooling the polymer fiber to a second predetermined temperature lower than the first predetermined temperature or exposing the polymer fiber to a cross-linking stimulus, the cross-linked polymer fiber capable of being decross-linked by heating to a third predetermined temperature above a characteristic decross-linking temperature of the polymer.

11. The method of claim 10, further comprising:
cooling the polymer fiber to a solidification temperature prior to cross-linking the polymer fiber so as to at least partially solidify the liquefied polymer.

12. The method of claim 10, wherein the polymer fiber is collected on a filter media substrate such that the polymer fibers form a filter media layer on the filter media substrate so as to form a filter media.

13. The method of claim 10, wherein the polymer network comprises one of Diels-Alder linkages, anthracene-dimer linkages, alkoxyamine linkages, or cinnamyl linkages.

14. The method of claim 10, wherein the polymer is formulated such that the polymer network comprises Diels-Alder linkages formed upon cooling the polymer fiber to the second predetermined temperature.

15. The method of claim 14, wherein the polymer comprises poly[(furfuryl methacrylate)-co-(butyl methacrylate)] (FMA-BMA) copolymer and a bismaleimide (M2) monomer cross-linked via furan-maleimide linkages generated by a Diels-Alder reaction.

16. The method of claim 10, wherein the polymer is formulated such that the polymer network comprises anthracene-dimer cross-linkages formed in response to exposing the uncross-linked polymer fiber to the cross-linking stimulus.

17. The method of claim 10, wherein the cross-linking stimulus includes one of ultraviolet light or sun light.

18. A filter media for a fluid filter prepared by a process comprising:
disposing a polymer into a melt blowing die;
heating the polymer to a first predetermined temperature in the melt blowing die so as to liquefy the polymer;
extruding the liquefied polymer through an orifice of the melt blowing die towards so as to form a polymer fiber; and
cross-linking the polymer fiber to form a cross-linked polymer fiber comprising a polymer network by at least one of cooling the polymer fiber to a second predetermined temperature lower than the first predetermined temperature or exposing the polymer fiber to a cross-linking stimulus, the cross-linked polymer fiber capable of being decross-linked by heating to a third predetermined temperature above a characteristic decross-linking temperature of the polymer.

19. The filter media of 18, wherein the polymer network comprises one of Diels-Alder linkages, anthracene-dimer linkages, alkoxyamine linkages, or cinnamyl linkages.

20. The filter media of claim 18, wherein the polymer comprises poly[(furfuryl methacrylate)-co-(butyl methacrylate)] (FMA-BMA) copolymer and a bismaleimide (M2) monomer cross-linked via furan-maleimide linkages generated by a Diels-Alder reaction.
